(19) United States
(12) Patent Application Publication
(10) Pub. No.: US 2024/0322979 A1
(43) Pub. Date: Sep. 26, 2024

(54) METHODS FOR ULTRA-RELIABLE LOW-LATENCY COMMUNICATION MULTIPLEXING

(71) Applicant: INTERDIGITAL PATENT HOLDINGS, INC., Wilmington, DE (US)

(72) Inventors: Paul Marinier, Brossard (CA); Faris Alfarhan, Montreal (CA); Patrick Tooher, Montreal (CA); Aata El Hamss, Laval (CA); Frank LaSita, Long Beach, NY (US)

(73) Assignee: INTERDIGITAL PATENT HOLDINGS, INC., Wilmington, DE (US)

(21) Appl. No.: 18/271,777

(22) PCT Filed: Jan. 10, 2022
(86) PCT No.: PCT/US2022/011875

§ 371 Date: Jul. 11, 2023

Related U.S. Application Data
(60) Provisional application No. 63/136,589, filed on Jan. 12, 2021.
(60) Provisional application No. 63/167,979, filed on Mar. 30, 2021.
(60) Provisional application No. 63/249,506, filed on Sep. 28, 2021.

(51) Int. Cl. H04L 5/00; H04W 72/1268; H04W 72/232

(52) U.S. Cl. CPC H04L 5/0055; H04W 72/1268; H04W 72/232

(57) ABSTRACT

Described herein is a procedure for determining multiplexing behavior when multiple physical uplink control channel (PUCCH) and/or physical uplink shared channel (PUSCH) resources of different priority indexes overlap in time. The wireless transmit/receive unit (WTRU) determines a multiplexing indication applicable to a set of resources overlapping in time, at least one condition associated to the multiplexing indication, and multiplexes a subset of the resources based on whether the at least one condition is satisfied. Further described herein are solutions for selecting a grant on which uplink control information (UCI) is multiplexed in the case that no data is available for transmission and the grants are of multiple priority indexes. Also described herein are solutions for reporting accurate power headroom applicable to simultaneous transmission of PUCCH and PUSCH when the PUCCH and PUSCH may be of different priority indexes.

### CROSS-REFERENCE TO RELATED APPLICATIONS

This application claims the benefit of U.S. Provisional Application No. 63/136,589 filed Jan. 12, 2021, U.S. Provisional Application No. 63/167,979 filed Mar. 30, 2021 and U.S. Provisional Application No. 63/249,506 filed Sep. 28, 2021; the contents of which are incorporated herein by reference.

### BACKGROUND

A wireless transmit/receive unit (WTRU) may have resources for physical uplink control channel (PUCCH) and/or physical uplink shared channel (PUSCH) transmissions that overlap in time, where the resource(s) for PUCCH may be for transmission of uplink control information such as HARQ-ACK, SR, LRR or channel state information (CSI). If the resources and associated physical downlink control channel (PDCCH) meet certain timeline conditions, the WTRU may multiplex the UCI and data (if any) into a single PUCCH or PUSCH transmission. This is often referred to as uplink control information (UCI) multiplexing.

### SUMMARY

Described herein is a procedure for determining multiplexing behavior when multiple physical uplink control channel (PUCCH) and/or physical uplink shared channel (PUSCH) resources of different priority indexes overlap in time. The wireless transmit/receive unit (WTRU) determines a multiplexing indication applicable to a set of resources overlapping in time, at least one condition associated to the multiplexing indication, and multiplexes a subset of the resources based on whether the at least one condition is satisfied.

Further described herein are solutions for selecting a grant on which uplink control information (UCI) is multiplexed in the case that no data is available for transmission and the grants are of multiple priority indexes.

Also described herein are solutions for reporting accurate power headroom applicable to simultaneous transmission of PUCCH and PUSCH when the PUCCH and PUSCH may be of different priority indexes.

Also described herein are solutions for uplink power control for multiplexed reports, prioritized power reduction as a function of priority of report including hybrid priority, resource allocation and rate matching as a function of priority of UCI, PHR for different PUCCH points.

A system, device and method for determining a DAI for a low-priority HARQ-ACK codebook based on a field received in a DCI indicating a high-priority PUCCH or PUSCH are described. The system, device and method include determining a first DAI value for low-priority HARQ-ACK codebook in a first DCI indication a high-priority PUCCH or PUSCH, determining a low-priority HARQ-ACK codebook to multiplex with high-priority HARQ-ACK codebook or PUSCH corresponding to the first DCI, adjusting the size of the low-priority HARQ-ACK codebook to be consistent with the first DAI value, and multiplexing the low-priority HARQ-ACK codebook with the high-priority HARQ-ACK codebook or PUSCH. Adjusting the size of the low-priority HARQ-ACK codebook may occur to be consistent with the first DAI value includes appending zeros. The first DAI value may indicate the HARQ-ACK codebook is priority 0. The first DAI value may indicate that the HARQ-ACK codebook is priority 1. The first DAI value may indicate a configuration to disable multiplexing with a HARQ-ACK codebook of priority index 0. The first DAI value may indicate disabling multiplexing into a PUSCH. The first DAI may indicate enabling multiplexing into a PUSCH.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates a HARQ-ACK of priority index 0 and HARQ-ACK and/or SR of priority index 1 into a PUCCH (at least for certain SR PUCCH formats);

FIG. 3 illustrates a HARQ-ACK of priority index 0 in PUSCH of priority index 1 conveying data and/or HARQ-ACK of priority index 1 and/or CSI;

FIG. 4 illustrates a HARQ-ACK of priority index 1 in PUSCH of priority index 0 conveying data and/or HARQ-ACK of priority index 0 and/or CSI;

FIG. 5 illustrates a multiplexing indication including a condition (MI1) that PUSCH of priority index 0 be included and a condition (MI2) that HARQ-ACK of priority index 0 be included;

FIG. 6 illustrates a multiplexing indication including a condition (MI1) that PUSCH of priority index 0 be included and a condition (MI2) that HARQ-ACK of priority index 0 be included;

FIG. 7 illustrates a multiplexing indication including a condition (MI1) that PUSCH of priority index 0 not be included and a condition (MI2) that HARQ-ACK of priority index 0 be included;

FIG. 8 illustrates a method for determining multiplexing behavior when multiple PUCCH and/or PUSCH resources of different priority indexes overlap in time;

FIG. 9 illustrates a method for the DAI of a first HARQ-ACK codebook in DCI indicating a second HARQ-ACK codebook;

FIG. 10 illustrates a method for the WTRU to determine or receive a DAI for a low-priority HARQ-ACK codebook based on a field received in a DCI indicating a high-priority PUCCH or PUSCH;

FIG. 11 illustrates a method for using a DAI in the DCI indicating PUSCH;

FIG. 12 illustrates a method used by a WTRU to determine the number of required PRBs for a PUCCH report by using a first and second configured maximum PUCCH coding rate parameters for low priority HARQ-ACK and first and second configured maximum PUCCH coding rate parameters for high priority HARQ-ACK;

FIG. 13 illustrates a method to determine which of the overlapping transmissions to transmit and/or multiplex together; and

FIG. 14 illustrates a method to determine which of the overlapping transmission is selected/transmitted and whether to build a TB for a grant overlapping with other transmission.

### DETAILED DESCRIPTION

Described herein is a procedure for determining multiplexing behavior when multiple physical uplink control channel (PUCCH) and/or physical uplink shared channel (PUSCH) resources of different priority indexes overlap in time. The wireless transmit/receive unit (WTRU) determines a multiplexing indication applicable to a set of resources overlapping in time, at least one condition associated to the multiplexing indication, and multiplexes a subset of the resources based on whether the at least one condition is satisfied.

Further described herein are solutions for selecting a grant on which uplink control information (UCI) is multiplexed in the case that no data is available for transmission and the grants are of multiple priority indexes.

Also described herein are solutions for reporting accurate power headroom applicable to simultaneous transmission of PUCCH and PUSCH when the PUCCH and PUSCH may be of different priority indexes.

Enabling multiplexing transmissions (e.g., UCI and other transmission) of different priority indexes is beneficial for spectral efficiency but carries the risk of worsening reliability and latency of the high priority (P1) transmission. If high priority UCI is multiplexed into low priority PUSCH, the latency of the high priority UCI may be increased. Multiplexing may result in the required power to meet the reliability target being higher than the maximum power. The present systems and methods multiplex high priority UCI with lower priority transmissions without sacrificing reliability/latency.

The WTRU may determine a multiplexing indication applicable to a set of resources overlapping in time that may be of different priority index. The WTRU may multiplex a subset of resources depending on the multiplexing indication (MI) and associated conditions. An associated condition may be that a resource of certain type and/or priority index must be one of the resources overlapping in time.

Enabling multiplexing transmissions of different priority indexes may be beneficial for spectral efficiency but carries the risk of worsening reliability and latency of the high priority (P1) transmission. This could happen, for instance, for missed PDCCH, latency and/or power. A PDCCH associated to a low priority (P0) transmission may be missed. In this case, there may be a mismatch between the UCI transmitted by WTRU and assumed by gNB and possible failure of decoding high-priority UCI and/or data. If high priority UCI is multiplexed into low priority PUSCH, the latency of the high priority UCI may be increased. The multiplexing may result in the required power (or PUSCH resources) to meet reliability target being higher than the maximum power.

UL skipping may increase the uncertainty of which transmission is received at the network side when there is possible overlap in time domain with PUCCH transmissions. The uncertainty may be worse when multiple transmissions of different priority index overlap.

A power headroom report applicable to a case where the WTRU transmits PUCCH and PUSCH simultaneously may not provide an accurate estimate of available power if the priority index of the PUCCH transmission assumed for the calculation of the report is different from the priority index of the PUCCH transmission of the actual transmission. The discrepancy may occur because the PUCCH power control configuration depends on the priority index.

The present systems and methods provide for selecting a grant on which UCI is multiplexed in the case that no data is available for transmission and the grants are of multiple priority indexes, and solutions for reporting accurate power headroom applicable to simultaneous transmission of PUCCH and PUSCH when the PUCCH and PUSCH may be of different priority indexes.

A system, device and method for determining a DAI for a low-priority HARQ-ACK codebook based on a field received in a DCI indicating a high-priority PUCCH or PUSCH are described. The system, device and method include determining a first DAI value for low-priority HARQ-ACK codebook in a first DCI indication a high-priority PUCCH or PUSCH, determining a low-priority HARQ-ACK codebook to multiplex with high-priority HARQ-ACK codebook or PUSCH corresponding to the first DCI, adjusting the size of the low-priority HARQ-ACK codebook to be consistent with the first DAI value, and multiplexing the low-priority HARQ-ACK codebook with the high-priority HARQ-ACK codebook or PUSCH. Adjusting the size of the low-priority HARQ-ACK codebook may occur to be consistent with the first DAI value includes appending zeros. The first DAI value may indicate the HARQ-ACK codebook is priority 0. The first DAI value may indicate that the HARQ-ACK codebook is priority 1. The first DAI value may indicate a configuration to disable multiplexing with a HARQ-ACK codebook of priority index 0. The first DAI value may indicate disabling multiplexing into a PUSCH. The first DAI may indicate enabling multiplexing into a PUSCH.

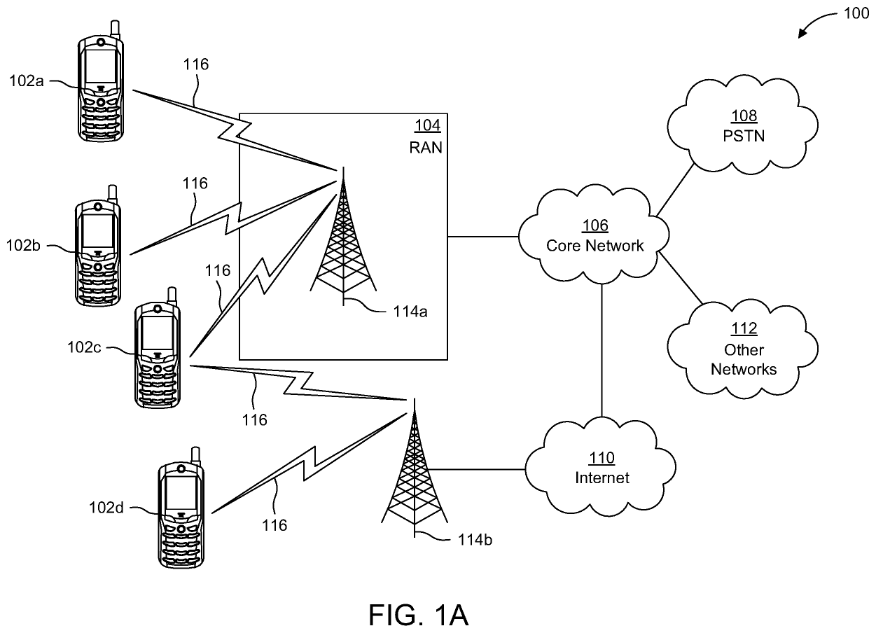

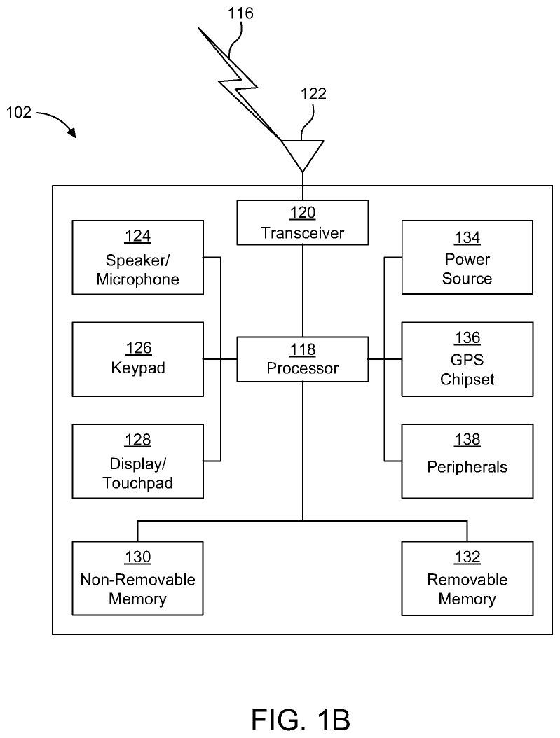

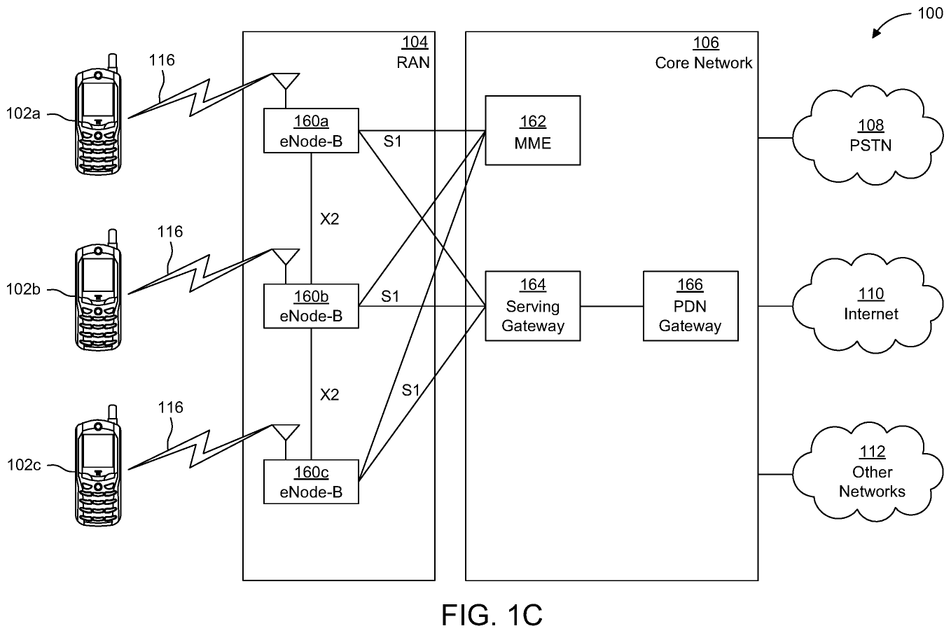

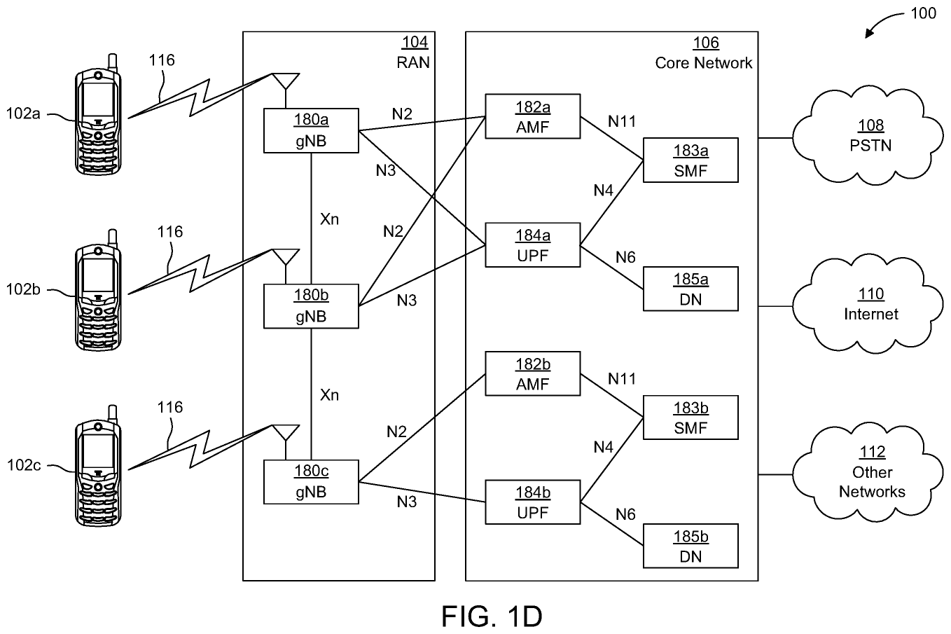

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHZ, 10 MHZ, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHZ. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A wireless transmit/receive unit (WTRU) may have resources for physical uplink control channel (PUCCH) and/or physical uplink shared channel (PUSCH) transmissions that overlap in time, where the resource(s) for PUCCH may be for transmission of uplink control information such as HARQ-ACK, SR, LRR or channel state information (CSI). If the resources and associated physical downlink control channel (PDCCH) meet certain timeline conditions, the WTRU may multiplex the UCI and data (if any) into a single PUCCH or PUSCH transmission. This is often referred to as uplink control information (UCI) multiplexing.

A PUSCH or PUCCH transmission may be of priority index 0 or of priority index 1. After resolving overlapping transmissions of a same priority, if a transmission of priority index 0 overlaps in time with a transmission of priority index 1, the WTRU cancels the transmission of priority index 0. Multiplexing the UCI or data from transmissions of different priority indexes is generally not supported. Intra-WTRU multiplexing of traffic with different priority may be specified. A specification may include multiplexing behavior among HARQ-ACK/SR/CSI and PUSCH for traffic with different priorities.

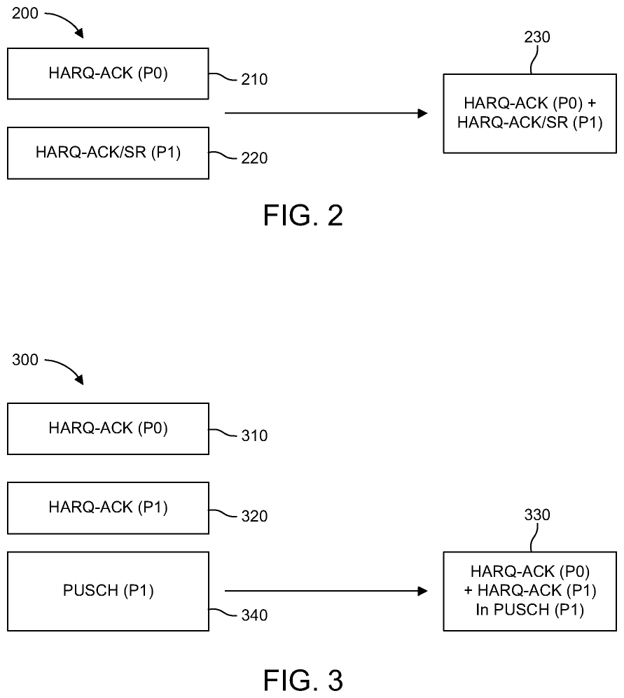

FIG. 2 illustrates a HARQ-ACK of priority index 0 and HARQ-ACK and/or SR of priority index 1 into a PUCCH (at least for certain SR PUCCH formats). Specifically, FIG. 2 illustrates an example priority transmission 200. Transmission 200 includes a first transmission of a HARQ-ACK of priority index 0 210. Transmission includes a second transmission of a HARQ-ACK and/or SR of priority index 1 220. The transmission 200 includes a combination of the HARQ-ACK of priority index 0 210 and HARQ-ACK and/or SR of priority index 1 220 into a PUCCH (at least for certain SR PUCCH formats) (collectively 230) as supported in RAN 1.

FIG. 3 illustrates a HARQ-ACK of priority index 0 in PUSCH of priority index 1 conveying data and/or HARQ-ACK of priority index 1 and/or CSI. Specifically, FIG. 3 illustrates an example priority transmission 300. Transmission 300 includes a first transmission of a HARQ-ACK of priority index 0 310. Transmission 300 includes a second transmission HARQ-ACK of priority index 1 320. The transmission 300 includes a combination the HARQ-ACK of priority index 0 310 in PUSCH of priority index 1 340 conveying data and/or HARQ-ACK of priority index 1 320 and/or CSI (collectively 330) as supported in RAN 1.

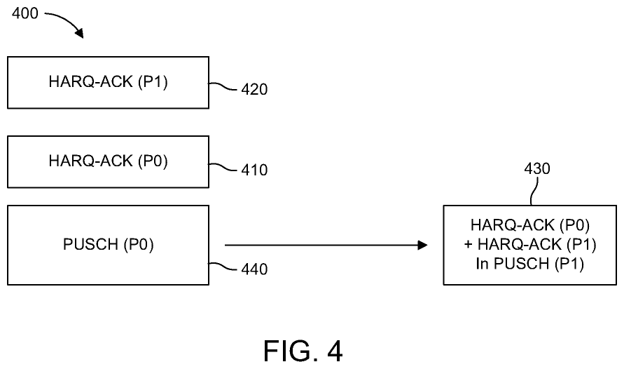

FIG. 4 illustrates a HARQ-ACK of priority index 1 in PUSCH of priority index 0 conveying data and/or HARQ-ACK of priority index 0 and/or CSI. Specifically, FIG. 4 illustrates an example priority transmission 400. Transmission 400 includes a first transmission of a HARQ-ACK of priority index 1 420. Transmission 400 includes a second transmission of a HARQ-ACK of priority index 0 410. The transmission includes a combination of the HARQ-ACK of priority index 1 420 in PUSCH of priority index 0 440 conveying data and/or the HARQ-ACK of priority index 0 410 and/or CSI (collectively 430) as supported in RAN 1.

There may be a simultaneous PUSCH and PUCCH transmission. A simultaneous transmission of PUCCH and PUSCH is generally not supported, however, this feature may be beneficial at least in the case when the WTRU transmits PUCCH and PUSCH in different frequency bands. A simultaneous transmission of PUCCH and PUSCH may be supported. For example, in power headroom reporting of Type 2 where the WTRU reports a power headroom applicable to a case where the WTRU transmits PUCCH and PUSCH simultaneously.

Further, UL skipping may occur. The MAC entity may not generate a MAC PDU if a MAC PDU includes zero MAC SDU and additional condition may be satisfied. For example, one additional condition includes no aperiodic CSI is requested for the PUSCH transmission. The additional conditions may be applicable to certain scenarios.

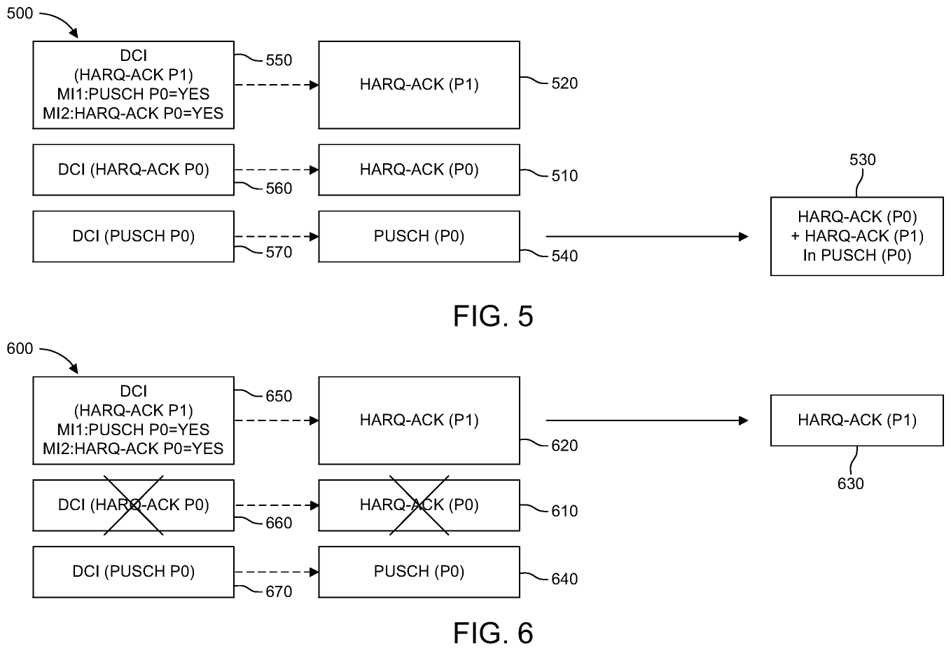

FIG. 5 illustrates a multiplexing indication including a condition (MI1) that PUSCH of priority index 0 be included and a condition (MI2) that HARQ-ACK of priority index 0 be included. Specifically, FIG. 5 illustrates an example transmission 500. As illustrated in the example transmission 500 of FIG. 5, a multiplexing indication 550 includes a condition (MI1) that PUSCH of priority index 0 be included and a condition (MI2) that HARQ-ACK of priority index 0 be included. PUSCH MI1 of indication 550 indicates to multiplex high priority HARQ 520 with low priority PUSCH 540. HARQ MI2 of indication 550 indicates to multiplex high priority HARQ 520 with low priority HARQ 510. The WTRU receives DCIs indicating low priority HARQ PUCCH 560 and low priority PUSCH 570 overlap with the high priority HARQ PUCCH. The WTRU multiplexes the high priority HARQ 520 and the low priority HARQ 510 in the low priority PUSCH 540 for transmission 530. Since both corresponding resources are present (indicated by respective DCI 550, 560, 570 in this case), the WTRU multiplexes the information in a single PUSCH transmission.

FIG. 6 illustrates a multiplexing indication including a condition (MI1) that PUSCH of priority index 0 be included and a condition (MI2) that HARQ-ACK of priority index 0 be included. Specifically, FIG. 6 illustrates an example transmission 600 for a mis-detection example. As illustrated in the example transmission 600 of FIG. 6, a multiplexing indication 650 includes a condition (MI1) that PUSCH of priority index 0 be included and a condition (MI2) that HARQ-ACK of priority index 0 be included. The WTRU missed the PDCCH indicating 660 the resource for HARQ-ACK of priority index 0 610. PUSCH MI1 of indication 650 indicates to multiplex high priority HARQ 620 with low priority PUSCH 640. HARQ MI2 of indication 650 indicates to multiplex high priority HARQ 620 with low priority HARQ 610. The WTRU receives the DCI indicating low priority PUSCH 640 overlaps with the high priority HARQ PUCCH. The WTRU does not receive the DCI indicating the low priority HARQ PUCCH. The WTRU transmits the high priority HARQ 620 on its own high priority PUCCH 630. Although the indication is to multiplex into PUSCH, the multiplex of high priority HARQ occurs due to mis-detection causing confusion. Since the resource is not present, the WTRU does not multiplex HARQ-ACK of priority index 1 620 into lower priority PUSCH transmission 640, and only transmit the HARQ-ACK of priority index 1 620 on its corresponding PUCCH resource instead. Such a configuration maintains robustness of that transmission since the network can easily detect that the WTRU did not transmit the PUSCH transmission.

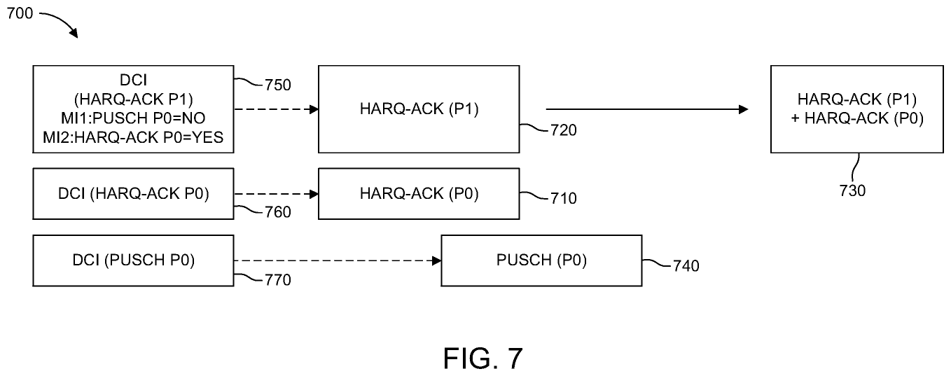

FIG. 7 illustrates a multiplexing indication including a condition (MI1) that PUSCH of priority index 0 not be included and a condition (MI2) that HARQ-ACK of priority index 0 be included. Specifically, FIG. 6 illustrates an example transmission 700 for a PUCCH multiplex example. As illustrated in the example transmission 700 of FIG. 7, a multiplexing indication 750 includes a condition (MI1) that PUSCH of priority index 0 not be included and a condition (MI2) that HARQ-ACK of priority index 0 be included. The PUSCH MI1 of indication 750 indicates to not multiplex high priority HARQ 720 with low priority PUSCH 740. The HARQ MI2 of indication 750 indicates to multiplex high priority HARQ 720 with low priority HARQ 710. The WTRU receives DCIs 750, 760, 770 indicating low priority HARQ PUCCH 760 and low priority PUSCH 770 overlap with the high priority HARQ PUCCH. The WTRU transmits the high priority HARQ 720 and low priority HARQ 710 on the high priority HARQ PUCCH. The network may have set the indication to exclude PUSCH because excessive latency to the HARQ-ACK of priority index 1 may occur or because transmit power requirement maybe too high. The gNB may indicate to not multiplex in the PUSCH due to latency, power, etc.

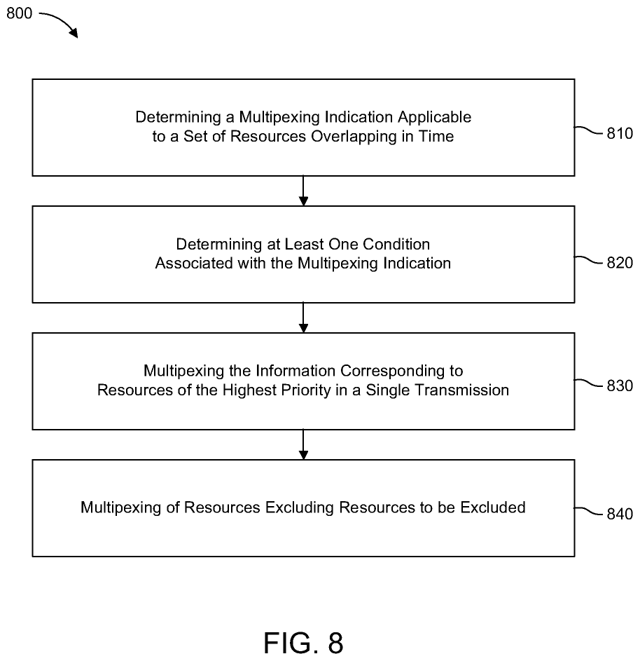

FIG. 8 illustrates a method 800 for determining multiplexing behavior when multiple PUCCH and/or PUSCH resources of different priority indexes overlap in time. Method 800 includes, at 810, the WTRU determining a multiplexing indication applicable to a set of resources overlapping in time. This determination may be made from an explicit indication in a PDCCH or RRC and implicitly based on property of a PDCCH or of at least one resource.

At 820, method 800 includes the WTRU determines at least one condition associated with the multiplexing indication. This determination may include a resource of a certain type and/or priority index included in the set of resources to be multiplexed together [with certain DAI] and may include a resource of a certain type and/or priority index excluded from the set of resources to be multiplexed together.

When there is a condition that a resource of a certain type and/or priority index be included in the set of resources to be multiplexed together, and the condition is not satisfied, method 800 includes, at 830, a multiplexing of the information corresponding to resources of the highest priority in a single transmission.

Alternatively, method 800 may include at 840, multiplexing of resources including the set, excluding any resource that is to be excluded as per a condition. Excluded resources may be dropped or transmitted separately.

As described, the present systems and methods, including the examples 200, 300, 400, 500, 600, 700 allow the network (or any other device including the WTRU, such as in a sidelink configuration, for example) to easily control whether multiplexing occurs or not in a specific situation, and the network is robust to missed detections of PDCCH associated to low priority transmissions.

A property of a grant or assignment include at least one of a frequency allocation, an aspect of time allocation, such as a duration, a priority, a modulation and coding scheme, a transport block size, a number of spatial layers, a number of transport blocks, a TCI state, CRI or SRI, a number of repetitions, whether the repetition scheme is Type A or Type B, whether the grant is a configured grant type 1, type 2 or a dynamic grant, whether the assignment is a dynamic assignment or a semi-persistent scheduling (configured) assignment, a configured grant index or a semi-persistent assignment index, a periodicity of a configured grant or assignment, a channel access priority class (CAPC), and any parameter provided in a DCI, by MAC or by RRC for the scheduling the grant or assignment. A property of the data included in a transport block (TB) may refer to any parameter configuring a logical channel or radio bearer for which data may be included in the TB. For example, at least one of a logical channel priority, prioritized bit rate, logical channel group, RLC mode. By extension, a property of a grant or assignment may also refer to a property of the data included in the corresponding TB.

An indication by DCI may include one or more of an explicit indication by a DCI field or by RNTI used to mask CRC of the PDCCH and an implicit indication by a property such as DCI format, DCI size, Coreset or search space, Aggregation Level, first resource element of the received DCI (e.g., index of first Control Channel Element), where the mapping between the property and the value may be signaled by RRC or MAC.

A WTRU, such as the WTRUs of the examples 200, 300, 400, 500, 600, 700, may have resources for at least one PUCCH and/or at least one PUSCH transmissions that overlap in time. These resources may be referred to as “overlapping resources.” Each of the at least one PUCCH and/or PUSCH resource may be of priority index 0 (low priority) or priority index 1 (high priority). The WTRU may determine:

For at least one PUCCH, whether the WTRU multiplexes the corresponding UCI in the resources of a PUSCH;

For the WTRU that multiplexes the UCI of at least one PUCCH in the resources of a PUSCH, the amount of resources of the PUSCH utilized for each UCI, or for the combination of UCI; for at least one PUCCH, whether the WTRU multiplexes the corresponding UCI with the UCI corresponding to at least one other PUCCH on a same resource;

For UCI's corresponding to more than one PUCCH that are multiplexed together, whether the WTRU jointly or separately encodes the UCI's;

The coding rates employed for the joint or separate encoding of UCI;

For at least one PUCCH or at least one PUSCH, whether the WTRU cancels the transmission;

For at least one HARQ-ACK codebook or PDSCH group, whether the contents is deleted or kept for future transmission;

Whether the WTRU simultaneously transmits one PUCCH and at least one PUSCH;

Whether the WTRU applies HARQ-ACK bundling for at least one HARQ-ACK codebook, e.g., of priority index 1; and

The PUCCH or PUSCH resource that the WTRU utilizes for the transmission of UCI, a PUCCH configuration, and a PUCCH resource set.

A WTRU, such as the WTRUs of the examples 200, 300, 400, 500, 600, 700, may determine a multiplexing indication applicable to a set of overlapping resources. A multiplexing indication may be determined based on at least one of the following aspects corresponding to, applicable to, or associated to at least one of the overlapping resources: a property of a grant or assignment; RRC configuration; an indication by DCI (implicit or explicit); payload of UCI; type of UCI (e.g., HARQ-ACK, SR, CSI); in case UCI is HARQ-ACK, type of codebook; PUCCH format or DCI format; transport block size (for PUSCH); serving cell; bandwidth part; transmission power; priority index; PUCCH resource set applicable to UCI payload (either combined for multiple resources, or for a single resource); PUCCH resource indication; downlink assignment index (DAI) (counter or total); and MAC control element;

For example, a multiplexing indication for two HARQ-ACK codebooks may take one of at least the following values. In one example, the multiplexing may be disabled. The WTRU may not combine both HARQ-ACK codebooks in same resource. The WTRU may drop the HARQ-ACK codebook of lower priority, unless the lower priority can be transmitted in a different resource (i.e., multiplexed on PUSCH in case simultaneous PUCCH and PUSCH transmission is possible and enabled).

In another example, the multiplexing may be enabled. The WTRU may combine both HARQ-ACK codebooks in the same resource. The resource may be PUCCH or PUSCH, for example. The multiplexing may be enabled with joint coding. The WTRU may combine both HARQ-ACK codebooks in same resource (PUCCH or PUSCH), and the payloads may be concatenated prior to channel coding.

The multiplexing may be enabled with separate coding. The WTRU may combine both HARQ-ACK codebooks in same resource (PUCCH or PUSCH), and each payload may be separately encoded, or a first portion of a first HARQ-ACK codebook payload may be jointly encoded with a second HARQ-ACK codebook payload and a second portion may be separately encoded. The multiplexing may be enabled with bundling. The WTRU may first bundle the HARQ-ACK codebook of lower priority index into a fewer HARQ-ACK bit values (i.e., ACK only if all of a set of HARQ-ACK values are “ACK”, and NACK otherwise). The WTRU may then combine the bundled HARQ-ACK bit(s) with the HARQ-ACK payload of higher priority index. The multiplexing may be disabled and the HARQ-ACK codebook of priority index 0 may be stored in for future transmission. The WTRU may not combine both HARQ-ACK codebooks in same resource.

For example, a multiplexing indication for HARQ-ACK and PUSCH may take one of at least one of the following values. In one example, the multiplexing may be enabled. The WTRU may multiplex the HARQ-ACK in PUSCH. The HARQ-ACK may be from a single codebook or from two codebooks, possibly depending on the multiplexing indication for two codebooks described herein.

In another example, the multiplexing may be disabled. The WTRU may not multiplex the HARQ-ACK in PUSCH. The WTRU may cancel the resource of lower priority index. The WTRU may transmit on PUCCH and PUSCH separately if simultaneous PUCCH and PUSCH transmission is possible and enabled (e.g., by RRC configuration for the corresponding PUSCH serving cell). The multiplexing may be disabled and lower priority transmission canceled. The multiplexing may be disabled and simultaneous PUCCH and PUSCH transmission enabled.

In some solutions, the set of possible multiplexing indications may depend on RRC configuration or MAC signaling. For example, RRC may configure the WTRU such that a multiplexing indication for two HARQ-ACK codebooks includes only “multiplexing enabled” and “multiplexing enabled (bundling). In another example, RRC or MAC signaling may configure the WTRU such that a multiplexing indication for HARQ-ACK and PUSCH may only include either that multiplexing is enabled, or that multiplexing is disabled with simultaneous PUCCH and PUSCH transmission enabled.

The WTRU determine a multiplexing indication using one of the following solutions for different types of resources including a DCI field of a DCI carrying a downlink assignment indicating HARQ-ACK, a DCI field of a DCI carrying an uplink grant, and a DCI format. For example, a multiplexing indication may implicitly correspond to “disabled” for certain DCI formats, such as format 1-0 or format 0-0, an information element of the RRC configuration for a scheduling request (SR) resource, a DL SPS configuration for each of at least one DL SPS configuration, a configured grant for each of at least one configured grant configuration, a periodic CSI report configuration, a MAC control element for a DL SPS configuration or configured grant configuration, where an index of the applicable configuration may be included in the MAC CE, a HARQ-ACK codebook for HARQ-ACK of a specific priority index, and a periodic CSI report configuration.

A DCI field may be a newly defined field. Alternatively, an existing field (in some configurations with more bits) may be mapped to a multiplexing indication according to a mapping pre-defined or configured by higher layers. For example, at least one of the following existing fields may be used including time domain resource allocation (TDRA), PUCCH resource indicator (PRI), PDSCH-to-HARQ-ACK delay indicator (K1), transmit power control (TPC), new data indicator (NDI), new feedback indicator (NFI), PDSCH group index, priority indicator, and downlink assignment index (DAI).

In some solutions, the multiplexing indication may be associated with at least one resource of higher priority index (i.e., priority index 1) among a group of overlapping resources. For example, an extended priority indicator field of 2 bits in a DCI for downlink assignment may take one of the following possible values including a first value indicating priority index of 0, a second value indicating priority index of 1 and multiplexing with HARQ-ACK of priority index 0 disabled, a third value indicating priority index of 1 and multiplexing with HARQ-ACK of priority index 0 enabled and a fourth value indicating priority index of 1 and multiplexing with HARQ-ACK of priority index 0 enabled with bundling.

For example, an extended priority indicator field of 2 bits in a DCI for uplink grant may take one of the following possible values including a first value indicating priority index of 0, a second value indicating priority index of 1 and multiplexing with HARQ-ACK of priority index 0 disabled, where HARQ-ACK of priority index 0 is cancelled, a third value indicating priority index of 1 and multiplexing with HARQ-ACK of priority index 0 disabled, where HARQ-ACK of priority index 0 is separately transmitted on PUCCH, and a fourth value indicating priority index of 1 and multiplexing with HARQ-ACK of priority index 0 enabled.

The PUCCH configuration and/or PUCCH resource set function of multiplexing indication. The WTRU may be configured with at least one of a PUCCH configuration, set of PUCCH resource sets or PUCCH resources applicable to a scenario in which first and second HARQ-ACK codebooks of different priorities are multiplexed in the same resource. Upon reception of the multiplexing indication that indicates that multiplexing is enabled, the WTRU may determine a PUCCH resource based on such PUCCH configuration, set of resource sets and/or resources. Alternatively, at least one of the PUCCH configuration, set of resource sets and/or resources may be associated with a first or second PUCCH configuration for the first or second HARQ-ACK codebook, respectively. For example, the PUCCH configuration associated to HARQ-ACK codebook of priority index 1 may include additional PUCCH resource sets applicable to the case of multiplexing HARQ-ACK codebooks of different priorities.

The WTRU, such as the WTRUs of the examples 200, 300, 400, 500, 600, 700, may be configured with at least one of a PUCCH configuration, set of PUCCH resource sets or PUCCH resources applicable to a scenario in which a first and second HARQ-ACK codebooks of different priorities are multiplexed in the same resource. Upon reception of the multiplexing indication that indicates that multiplexing is enabled, the WTRU may determine a PUCCH resource based on such PUCCH configuration, set of resource sets and/or resources. Alternatively, at least one of the PUCCH configuration, set of resource sets and/or resources may be associated to a first or second PUCCH configuration for the first or second HARQ-ACK codebook, respectively. For example, the PUCCH configuration associated to HARQ-ACK codebook of priority index 1 may include additional PUCCH resource sets applicable to the case of multiplexing HARQ-ACK codebooks of different priorities.

For example, in some examples, a multiplexing indication and a resource for multiplexing may be determined. In these examples, the determination may include a WTRU configured at least one PUCCH resource set for each PUCCH configuration (e.g., corresponding to priority index 0 and priority index 1).

For at least one PUCCH resource set, the value indicated by a PUCCH resource indicator (PRI) may correspond to one of at least one possible multiplexing indication value instead of, or in addition to, a PUCCH resource identity. The WTRU may determine that a PUCCH resource carrying HARQ-ACK for priority index 1 may overlap with a PUCCH resource carrying HARQ-ACK for priority index 0, where the respective PUCCH resources may be determined based on the respective HARQ-ACK payloads. The WTRU may determine the PUCCH resource set corresponding to the combined HARQ-ACK payload of both priority index 0 and priority index 1. The PUCCH resource set may be selected from the PUCCH configuration corresponding to priority index 1. Such a resource set may be referred to as the “PUCCH resource set for combined HARQ-ACK”. The WTRU may determine a value of the multiplexing indication corresponding to the PUCCH resource indicator (PRI) value and PUCCH resource set for combined HARQ-ACK.

If no PUCCH resource is configured for the PRI value and the PUCCH resource set, the WTRU may determine that this configuration corresponds to an implicit indication to not multiplex the HARQ-ACK codebooks. In this configuration, or if there is a value of the multiplexing indication that corresponds to “multiplexing disabled”, the HARQ-ACK codebook of lower priority index may be dropped. The WTRU may determine a PUCCH resource for the HARQ-ACK codebook of priority index 1 based on the PUCCH resource set corresponding to the payload of that codebook. If a PUCCH resource is configured for this PRI value, and/or if the value is mapped to a multiplexing indication that corresponds to “multiplexing enabled”, “multiplexing enabled (joint coding)” or “multiplexing enabled (separate coding)”, the WTRU multiplexes the HARQ-ACK codebooks on this PUCCH resource. If the value is mapped to a multiplexing indication that corresponds to “multiplexing enabled, bundling”, the WTRU may determine a new combined payload when bundling is applied on the lower priority HARQ-ACK codebook and the PUCCH resource set corresponding to this new combined payload. The WTRU may then multiplex the new combined payload on the resource indicated by PRI for this PUCCH resource set.

Partial joint encoding may be used. The WTRU may encode UCI of different priority indexes and multiplex the coded bits on a same resource according to at least one of the following solutions. The UCI of different priority indexes may consist, for example, of the payload of a first HARQ-ACK codebook of priority 0 and the payload of a second HARQ-ACK codebook of priority 1. Such payloads may be referred to as priority 0 and priority 1 payloads.

The WTRU may separately encode a first and a second group of bits from the UCI. The first group of bits may include a first subset of bits from priority 0. The second group of bits may include a second subset of bits from priority 0 and the bits from priority 1. The second group of bits may be encoded using a lower coding rate than the first group of bits to enable higher level of reliability for the priority 1 bits for a given signal-to-noise ratio. Including a subset of the priority 0 bits in the second group, while not necessary, may enable use of more efficient coding technique for the second group and may reduce the minimum SNR required to reach or surpass the reliability targets of both priority 0 and priority 1 bits. This technique may be referred to as “partial joint encoding”. Any solution described in this document for enabling or indicating separate encoding of priority 0 and priority 1 bits is also applicable for partial joint encoding of priority 0 and priority 1 bits. The first and second groups may be referred to as “coding groups” in the following. The first and second coding groups may also be referred to as priority index 0 and 1 respectively, even if the second coding group may contain a subset of bits of priority 0.

The WTRU may determine the number of priority 0 bits included in the second group of bits based on at least one of the number of priority 0 bits (N0) and/or priority 1 bits (N1), a target coding rate applicable to priority 0 bits and/or priority 1 bits, and a maximum coding rate applicable to priority 0 bits and/or priority 1 bits. At least one parameter (e.g., S1, S2) representing a minimum number of bits for utilization of a specific coding scheme, such as S1=12 bits for polar encoding. At least one parameter may be pre-defined or signaled by RRC, MAC or PHY.

For example, the following solutions may apply. The WTRU may include all (N0) priority 0 bits in the second group if N1 is above 0 and if N0 is below a first threshold T0, if N0+N1 is below a second threshold T1 or if NO/N1 is below a third threshold. The WTRU may include the following number of priority 0 bits in the second group Zero (0) priority 0 bits if N1 is above a first parameter S1, S1-N1 priority 0 bits if N1 is below a first parameter S1 but above or equal to a second parameter S2, and N0+N1 is above or equal to S1, and S2-N1 priority 0 bits if N1 is below a second parameter S2, and N0+N1 is above or equal to S2.

For example, a first threshold T0 may be 4, a first parameter S1 may be 12 and a second parameter S2 may be 4. In case N0=3 bits and N1>0 bit, all N0+N1 bits may be included in the second group. In case N0=6 bits and N1=10 bits, first group may include 4 priority 0 bits, second group may include 2 priority 0 bits and 10 priority 1 bits. In case N0=8 bits and N1=2 bits, first group may include 6 priority 0 bits, second may include 2 priority 0 bits and 2 priority 1 bits.

A multiplexing indication may include an indication of whether to perform joint or separate coding of HARQ-ACK codebooks of different priority indexes, and of the coding rate(s). The indication may take one of a number of values. For example, a first value indicating separate coding and a first ratio between coding rates applicable to priority indexes 0 and 1, or to a first and second coding groups, a second value indicating separate coding and a second ratio between coding rates applicable to priority indexes 0 and 1, or to a first and second coding groups, a third value indicating separate coding and a third ratio between coding rates applicable to priority indexes 0 and 1, or to a first and second coding groups, and a fourth value indicating joint coding.

A normalized payload may be used. The WTRU may determine a normalized payload of HARQ-ACK as a function of the payloads of HARQ-ACK of priority index 0 and 1 and of their respective coding rates, or ratio thereof. For example, a normalized payload may be a sum of encoded payloads for each priority index or each coding group, where an encoded payload may be a payload divided by a coding rate for a priority index. For example, a normalized payload may be the sum of a payload of HARQ-ACK for a first priority index (e.g., priority index 1) and a payload of HARQ-ACK for a second priority index (e.g., priority index 0) multiplied by a ratio between the coding rate of the first priority index and the coding rate of the second priority index. The WTRU may use a normalized payload for the determination of at least one of the following: A PUCCH resource set applicable to at least the case of multiplexing HARQ-ACK of different priorities; A transmission power for PUCCH; and A number of resource elements allocated for the transmission of HARQ-ACK of a first and second priority indexes within a PUSCH transmission.

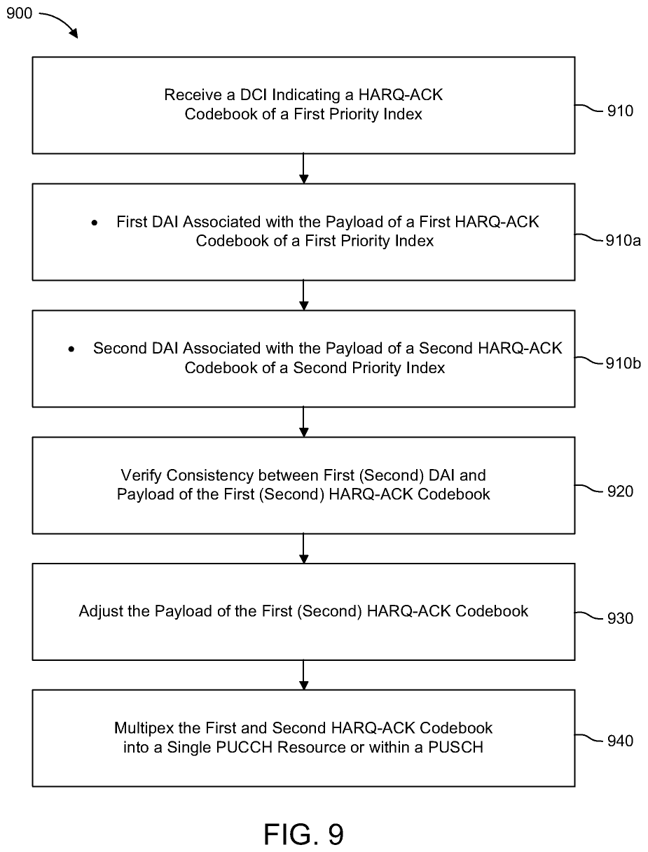

FIG. 9 illustrates a method 900 for the DAI of a first HARQ-ACK codebook in DCI indicating a second HARQ-ACK codebook. Method 900 includes, at 910, the WTRU receiving a DCI indicating a HARQ-ACK codebook of a first priority index (e.g., priority index 1) that may include a first DAI associated with the payload of a first HARQ-ACK codebook of a first priority index at 910a and a second DAI associated with the payload of a second HARQ-ACK codebook of a second priority index (e.g., priority index 0) at 910b. The WTRU may verify consistency between the first (second) DAI and the payload of the first (second) HARQ-ACK codebook at 920 and adjust the payload of the first (second) HARQ-ACK codebook at 930. At 940, the WTRU multiplexes the first and second HARQ-ACK codebooks into a single PUCCH resource or within a PUSCH, if a multiplexing indication is received for certain value(s).

In some solutions, at least one of a priority index, a multiplexing indication, a PRI and a DAI (associated to a HARQ codebook of different priority index) may be combined into a single field. For example, the WTRU may receive a priority index, a multiplexing indication and a DAI from a single field as per the following mapping. A first value indicates that the HARQ-ACK codebook is of priority index 0; a second value indicates that the HARQ-ACK codebook is of priority index 1 and the multiplexing indication is set to disable multiplexing; a third value indicates that the HARQ-ACK codebook is of priority index 1, the multiplexing indication is set to enable multiplexing and a DAI associated to the HARQ-ACK codebook of priority index 0 is of value 0; a fourth value indicates that the HARQ-ACK codebook is of priority index 1, the multiplexing indication is set to enable multiplexing and a DAI associated to the HARQ-ACK codebook of priority index 0 is of value 1; and so on.

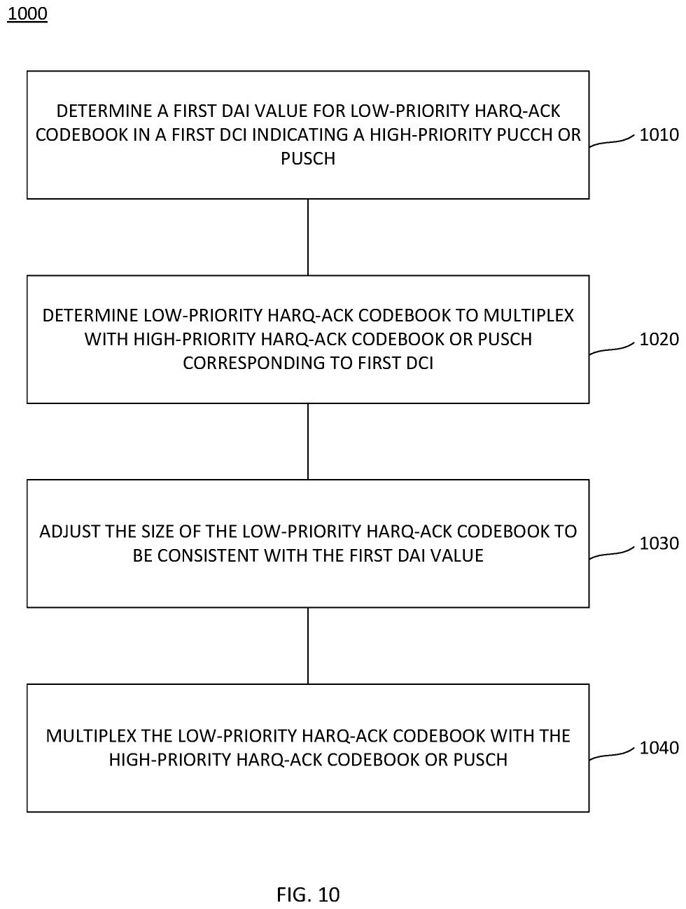

FIG. 10 illustrates a method 1000 for the WTRU to determine or receive a DAI for a low-priority HARQ-ACK codebook based on a field received in a DCI indicating a high-priority PUCCH or PUSCH. Method 1000 includes, at 1010, the WTRU determining a first DAI value for low-priority HARQ-ACK codebook in a first DCI indication a high-priority PUCCH or PUSCH. At 1020, method 1000 includes the WTRU determining a low-priority HARQ-ACK codebook to multiplex with high-priority HARQ-ACK codebook or PUSCH corresponding to the first DCI. At 1030, method 1000 includes the WTRU adjusting the size of the low-priority HARQ-ACK codebook to be consistent with the first DAI value, e.g., by appending zeros (0). At 1040, method includes the WTRU multiplexing the low-priority HARQ-ACK codebook with the high-priority HARQ-ACK codebook or PUSCH.

In another example, the WTRU may receive a priority index, a multiplexing indication for HARQ-ACK, a multiplexing indication for PUSCH, and a DAI from a single field. The WTRU may receive a DCI with a field of the DCI set to one out of 8 possible values. The field of the DCI may be set by the network, for example. In such an example, the field may indicate one out of eight (8) possible values in a DCI indicating a downlink transmission and PUCCH resource for HARQ-ACK. A first value may indicate that the HARQ-ACK codebook is of priority index 0 while remaining seven (7) values may indicate that the HARQ-ACK codebook is of priority index 1, for example. A second value may indicate a configuration to disable multiplexing with a HARQ-ACK codebook of priority index 0 and disable multiplexing into a PUSCH. A third value may indicate a configuration to disable multiplexing with a HARQ-ACK codebook of priority index 0 and enable multiplexing into a PUSCH. A fourth value may indicate a configuration to enable multiplexing with a HARQ-ACK codebook of priority index 0 and enable multiplexing into a PUSCH. Each of the remaining four (4) values may indicate a configuration to enable multiplexing with a HARQ-ACK codebook of priority 0, to disable multiplexing in a PUSCH, and the value of a DAI.

In another example, the WTRU may receive a multiplexing indication, a PRI and a DAI from a single field as per the following mapping. A sub-field may correspond to a multiplexing indication. For a first value of the sub-field, the remaining bits include a 3-bits PRI. For a second value of the sub-field, the remaining bits include a 1-bit PRI and a 2-bit DAI.

In another example, the WTRU may receive a priority indication and a DAI associated with an HARQ codebook of different priority index from a single field. In the example presented above, the field may indicate one out of four (4) possible values in a DCI. A first value may indicate that the HARQ-ACK codebook indicated by the DCI has priority index 0. The remaining values (i.e. second, third and fourth) may indicate that the HARQ-ACK codebook indicated by the DCI has priority index 1 and each value may also indicate the DAI associated to an HARQ codebook of priority index 0. Such a DAI may be referred to as DAI_LP in the following. For example, the second value may indicate DAI_LP=0, the third value may indicate DAI_LP=1 and the fourth value may indicate DAI_LP=3.

In a first configuration, the WTRU may receive a first DCI indicating a downlink assignment with a first PUCCH for transmission of HARQ-ACK information of priority index 1 and a DAI_LP value. The WTRU may also receive configuration or indication (e.g., by DCI or RRC) for the transmission of a second PUCCH carrying HARQ-ACK information of priority index 0. If the first and second PUCCH satisfy timing and/or other conditions for multiplexing, the WTRU may multiplex HARQ-ACK information corresponding to priority index 0 and 1 in a single resource. The WTRU may adjust the payload of HARQ-ACK information corresponding to priority index 0 so that it is consistent with the received DAI_LP, for example, by appending at least one zero (0) value to the codebook.

In a second configuration, the WTRU may receive a DCI indicating a downlink assignment with a first PUCCH for transmission of HARQ-ACK information of priority index 1 and a DAI_LP value. If the received DAI_LP value is non-zero and the WTRU did not receive configuration or indication for transmission of a second PUCCH carrying HARQ-ACK information of priority index 0, the WTRU may multiplex the HARQ-ACK information corresponding to priority index 1 with HARQ-ACK information corresponding to priority index 0 in a single resource, where the HARQ-ACK information corresponding to priority index 0 includes of a number DAI_LP of zero (0) values. This first and second solutions enable the WTRU to transmit the correct number of HARQ-ACK bits of priority index 0 even if it missed corresponding DCI's.

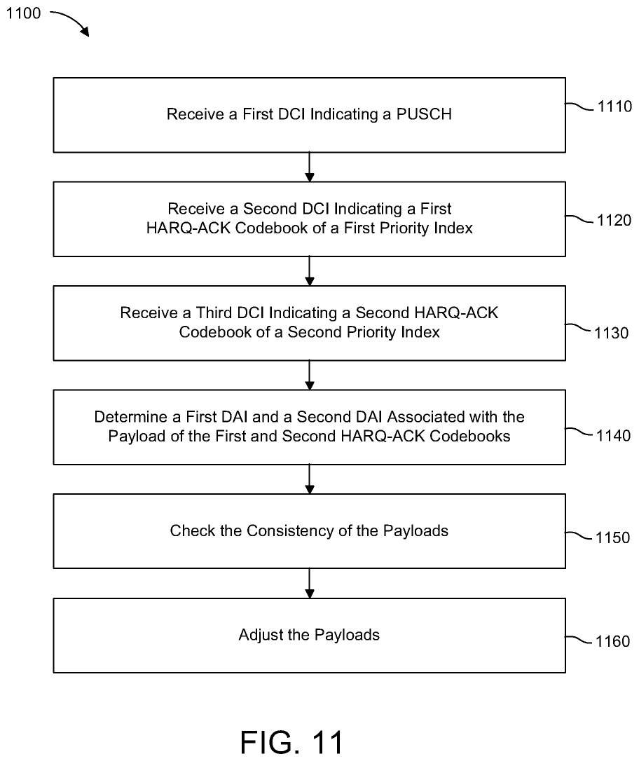

FIG. 11 illustrates a method 1100 for using a DAI in the DCI indicating PUSCH. At 1110, the WTRU receives a first DCI indicating a PUSCH. At 1120, the WTRU receives a second DCI indicating a first HARQ-ACK codebook of a first priority index (e.g., priority index 1). At 1130, the WTRU receives a third DCI indicating a second HARQ-ACK codebook of second priority index (e.g., priority index 0).

At 1140, the WTRU determines a first DAI and a second DAI associated with the payload of the first and second HARQ-ACK codebooks, respectively. At 1150, the WTRU checks the consistency of the payload of the first and second HARQ-ACK codebooks. At 1160, the WTRU adjusts the payload of the first and second HARQ-ACK codebooks prior to multiplexing in PUSCH as described.

The WTRU may determine first and second DAI's based on one the following solutions. In a solution, in case the WTRU receives first, second and third DCI, a field in the first DCI corresponds to first DAI and the second DAI is received from a field of the second DCI. Otherwise, in case the receives first and third DCI only, or first and second DCI only, a field in the first DCI corresponds to the DAI associated to the HARQ codebook indicated by the second (or third) DCI. In another solution, a first field in the first DCI corresponds to a first DAI and a second field in the first DCI corresponds to a second DAI.

The WTRU may determine a normalized payload of HARQ-ACK as a function of the payloads of HARQ-ACK of priority index 0 and 1 and of their respective coding rates, or ratio thereof. For example, a normalized payload may include a sum of encoded payloads for each priority index, where an encoded payload may be a payload divided by a coding rate for a priority index. For example, a normalized payload may include the sum of a payload of HARQ-ACK for a first priority index (e.g., priority index 1) and a payload of HARQ-ACK for a second priority index (e.g., priority index 0) multiplied by a ratio between the coding rate of the first priority index and the coding rate of the second priority index. The WTRU may use a normalized payload for the determination of at least one of the following: a PUCCH resource set applicable to at least the case of multiplexing HARQ-ACK of different priorities; a transmission power for PUCCH; and a number of resource elements allocated for the transmission of HARQ-ACK of a first and second priority indexes within a PUSCH transmission.

The WTRU may receive a DCI indicating a HARQ-ACK codebook of a first priority index (e.g., priority index 1) that may include a first DAI associated to the payload of a first HARQ-ACK codebook of a first priority index and a second DAI associated to the payload of a second HARQ-ACK codebook of a second priority index (e.g., priority index 0). The WTRU may verify consistency between the first (second) DAI and the payload of the first (second) HARQ-ACK codebook and adjust the payload of the first (second) HARQ-ACK codebook. The WTRU may then multiplex the first and second HARQ-ACK codebooks into a single PUCCH resource or within a PUSCH, possibly if a multiplexing indication is received for certain value(s).

In some solutions, at least one of a priority index, a multiplexing indication, a PRI and a DAI (associated to a HARQ codebook of different priority index) may be combined into a single field. For example, the WTRU may receive a priority index, a multiplexing indication and a DAI from a single field as per the following mapping. A first value indicates that the HARQ-ACK codebook is of priority index 0; a second value indicates that the HARQ-ACK codebook is of priority index 1 and the multiplexing indication is to disable multiplexing; a third value indicates that the HARQ-ACK codebook is of priority index 1, the multiplexing indication is to enable multiplexing and a DAI associated to the HARQ-ACK codebook of priority index 0 is of value 0; a fourth value indicates that the HARQ-ACK codebook is of priority index 1, the multiplexing indication is to enable multiplexing and a DAI associated to the HARQ-ACK codebook of priority index 0 is of value 1; and so on.

In another example, the WTRU may receive a multiplexing indication, a PRI and a DAI from a single field as per the following mapping. A sub-field may correspond to a multiplexing indication. For a first value of the sub-field, the remaining bits include a 3-bits PRI; for a second value of the sub-field, the remaining bits include a 1-bit PRI and a 2-bit DAI.

The WTRU may receive a first DCI indicating a PUSCH, a second DCI indicating a first HARQ-ACK codebook of first priority index (e.g., priority index 1) and a third DCI indicating a second HARQ-ACK codebook of second priority index (e.g., priority index 0). The WTRU may determine a first DAI and a second DAI associated to the payload of the first and second HARQ-ACK codebooks, respectively, for the purpose of checking consistency and/or payload adjustment prior to multiplexing in PUSCH as described.

The WTRU may determine first and second DAI's. In a solution, if the WTRU receives first, second and third DCI, a field in the first DCI corresponds to first DAI and the second DAI is received from a field of the second DCI. If the WTRU receives first and third DCI, or first and second DCI, a field in the first DCI corresponds to the DAI associated to the HARQ codebook indicated by the second (or third) DCI. In another solution, a first field in the first DCI corresponds to a first DAI and a second field in the first DCI corresponds to a second DAI.

In some solutions, the WTRU may separately encode and multiplex two HARQ-ACK codebooks (or two UCI's) of different priority indexes in a PUSCH transmission. The WTRU may determine the number of coded modulation symbols per layer Q for each of the two HARQ-ACK codebooks.

In some solutions, the WTRU may determine one set of parameters (Beta offset, alpha) for each priority index and may determine the number of symbols Q for each HARQ-ACK codebook based on respective set of parameters for corresponding priority index using existing formulas. The WTRU may determine a set of parameters for a priority index.

In a solution, the WTRU receives signaling that explicitly indicates the values of each set of parameters. Such signaling may be from RRC, MAC or DCI. For example, RRC, MAC or DCI signaling explicitly indicating each set of parameters. For example, RRC may configure a set of parameters for each priority index for each possible value of a DCI field. Alternatively, separate DCI fields may indicate a set of parameters for respective priority indexes.

In a solution, the WTRU receives signaling that explicitly indicates the value of one set of parameters. The WTRU calculates the values for a second set of parameters using a coding rate ratio or other factor. For example, the WTRU may receive the values of a set of parameters applicable to priority index 1 from explicit signaling. The WTRU may determine the values of the set of parameters applicable to priority 0 based on a ratio of coding rates. The ratio of coding rates may be pre-defined, configured by higher layers or signaled dynamically by a coding indication.

Resource allocation may occur when the two UCI groups are separately encoded on PUCCH. In some solutions, the WTRU may separately encode and multiplex two HARQ-ACK codebooks (or two UCI's) of different priority indexes in a PUCCH transmission, or separately encode two coding groups as described. The WTRU may determine the number of coded modulation symbols used for each of the two HARQ-ACK codebooks or coding groups using at least one of the following solutions:

In some solutions, the WTRU may determine one set of parameters for each priority index or coding group to determine the number of symbols required for each HARQ-ACK codebook based on the respective set of parameters for the corresponding priority index or coding group using existing formulas. Parameter sets may consider a prioritized distribution of the total resources, e.g., time and frequency resources, based upon the priority indices of codebooks. Parameter sets may allocate a percentage of the total available resources to each codebook such that the total of all the available resources are used. A larger portion of the available resources can be used to lower the coding rate for a codebook and enable a higher level of reliability for higher priority codebooks. Parameter sets may select resources which insure earlier, or enhanced reception based upon priority of each codebook. Use of resources mapped earlier in time than the remaining transmission resources may be used for codebooks priorities with more stringent latency requirements. Enhanced reception techniques may provide a higher level of reliability for the codebook, e.g., techniques which increase frequency diversity of resources could be used for a higher priority codebook. The WTRU may determine a set of parameters for a priority index or coding group using at least one of the following:

In a solution, the WTRU receives signaling that explicitly indicates the values of each set of parameters. Such signaling may be from RRC, MAC or DCI. For example, RRC, MAC or DCI signaling explicitly indicating each set of parameters. For example, RRC may configure a set of parameters for each priority index or coding group for each possible value of a DCI field. Alternatively, separate DCI fields may indicate a set of parameters for respective priority indexes.

In a solution, the WTRU receives signaling that explicitly indicates the value of one set of parameters. The WTRU calculates the values for a second set of parameters using a coding rate ratio or other factor. For example, the WTRU may receive the values of a set of parameters applicable to priority index 1 based on explicit signaling. The WTRU may determine the values of the set of parameters applicable to priority 0 based on a ratio of coding rates. The ratio of coding rates may be pre-defined, configured by higher layers or signaled dynamically by a coding indication. The parameter set may also include other values which indicate the resources used for each priority index, e.g., the order or mapping of time and frequency resources used.

In a solution, a WTRU may determine the required number of PRBs for a PUCCH report as a function of the sum of number of HP HARQ-ACK bits scaled (e.g., multiplied) by a first offset value or scaling factor and LP HARQ-ACK bits scaled (e.g., multiplied) by a second offset value or scaling factor. The scaling offsets may be determined as a function of a minimum coding rate ratio.

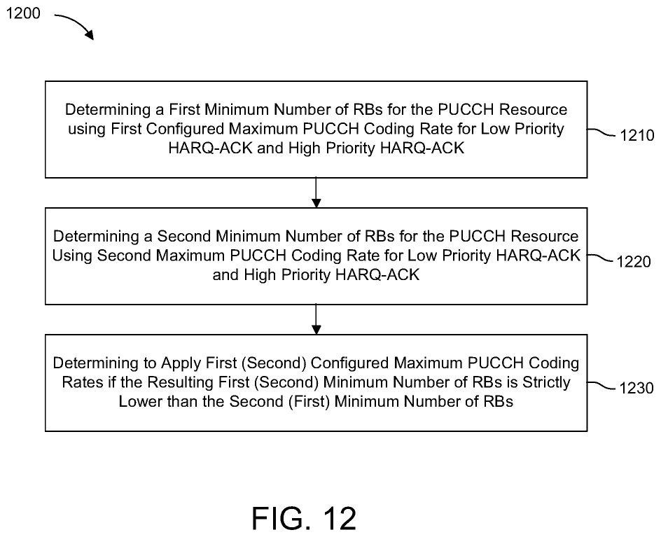

FIG. 12 illustrates a method 1200 used by a WTRU to determine the number of required PRBs for a PUCCH report by using a first and second configured maximum PUCCH coding rate parameters for low priority HARQ-ACK and first and second configured maximum PUCCH coding rate parameters for high priority HARQ-ACK. At 1210, method 1200 includes the WTRU determining a first minimum number of RBs for the PUCCH resource using first configured maximum PUCCH coding rate for low priority HARQ-ACK and high priority HARQ-ACK, such that the number or resource elements in the PUCCH resource would be sufficient to accommodate coded bits of both low priority and high priority HARQ-ACK bits.

At 1220, method 1200 includes the WTRU determining a second minimum number of RBs for the PUCCH resource using second maximum PUCCH coding rate for low priority HARQ-ACK and high priority HARQ-ACK, such that the number or resource elements in the PUCCH resource would be sufficient to accommodate coded bits of both low priority and high priority HARQ-ACK bits.

At 1230, method 1200 includes the WTRU determining to apply first (second) configured maximum PUCCH coding rates parameters if the resulting first (second) minimum number of RBs is strictly lower than the second (first) minimum number of RBs. If first and second minimum number of RBs are equal, the WTRU may determine to apply first (second) configured maximum PUCCH coding rates if the first (second) configured maximum PUCCH coding rate for high-priority HARQ-ACK is lower than the second (first) configured maximum PUCCH coding rate for high-priority HARQ-ACK. This solution has the benefit of allowing as low as possible a coding rate for the high-priority HARQ-ACK while still providing acceptable coding rate for low-priority HARQ-ACK and without consuming excessive resources. The first and second configured maximum PUCCH coding rates may be provided by RRC signaling for each PUCCH format. The configured maximum PUCCH coding rate parameters that the WTRU determines to apply can be used in the rate matching procedure as well as in power control procedure.

The WTRU may multiplex the UCI and/or data corresponding to a first and second overlapping resource in a single resource under at least one condition associated to a third resource. A condition may be that the third resource is present and overlaps in time with the first and/or second resource. A condition may be that the third resource would be for HARQ-ACK, and that the number of bits of HARQ-ACK is consistent with a downlink assignment index (DAI), either counter DAI or total DAI. Such a DAI may be indicated as part of the multiplexing indication or separately by DCI or RRC. If the at least one condition is satisfied, the WTRU may multiplex the UCI and/or data corresponding to the first, second and third resource together in a same resource. If the at least one condition is not satisfied, the WTRU may not multiplex the UCI and/or data corresponding to the first and second overlapping resources. This may apply even if a multiplexing indication pertaining to the first and second overlapping resources would indicate that multiplexing is enabled. The WTRU may transmit one of the first and second overlapping resources (of higher priority index) and cancel the other (of lower priority index).

In some solutions, the WTRU may transmit or multiplex UCI and/or data corresponding to a first resource in a second resource under at least one condition associated to the second resource. A condition may be that the time difference between the end of the first resource and the end of the second resource does not exceed a threshold, or that the duration of the second resource does not exceed a threshold, or that the second resource is one of a specific set of allowed PUCCH formats. The threshold and/or set of allowed PUCCH formats may be pre-defined or configured by higher layer for the first resource. For example, in case the first resource is a SR resource, the RRC configuration of the SR resource may include the threshold and/or set of allowed PUCCH formats.

A WTRU may be configured with more than one grant overlapping in time domain, where each grant may be associated with respective multiplexing indication. The WTRU may select one of the grants for transmission of PUSCH based on the presence or absence of overlapping resources and based on the multiplexing indication of each grant. For example, if the grants are of priority index 1 and overlap with a PUCCH resource for HARQ-ACK of priority index 0, the WTRU may select a grant for which a multiplexing indication indicates that multiplexing with a PUCCH of priority index 0 is enabled. If the multiplexing indication for each grant includes a total DAI, the WTRU may select a grant for which the total DAI is consistent with the HARQ-ACK codebook carrier by the PUCCH of priority index 0.

A WTRU may be configured to transmit PUSCH on more than one serving cell, where the PUSCH on each serving cell may be of different priority indexes. A WTRU may also have overlapping PUCCH resources of different priority indexes. The WTRU may multiplex the UCI of a PUCCH of a given priority index into a PUSCH on a selected serving cell, among the PUSCH for which multiplexing is possible and enabled for this PUCCH. The WTRU may start with the PUCCH(s) of priority index 1 and then with the PUCCH(s) of priority index 0. If there is more than one PUSCH for which multiplexing is possible, the WTRU may select the PUSCH based on a priority order. The prioritization may consider whether the PUSCH and PUCCH have same priority index, i.e., the WTRU may prioritize a PUSCH with same priority index as PUCCH over a PUSCH of different priority index, whether UCI of higher priority index is multiplexed on the PUSCH or not; i.e., the WTRU may prioritize a PUSCH on which UCI of higher priority index is not multiplexed over a PUSCH on which it is multiplexed, and prioritization criteria already supported in current system, e.g., based on lowest serving cell identity, whether aperiodic CSI is triggered or not. The WTRU may also prioritize PUSCH with highest priority index regardless of the priority index of PUCCH.

In another solution, each PUCCH and/or PUSCH may be associated with a multiplexing group. The multiplexing group may be signaled using at least one solution already described for the multiplexing indication. The WTRU may multiplex PUCCH's and PUSCH's that are associated to a same multiplexing group.

UL Transmission Power Control is also described. A WTRU may determine the transmission power of a PUCCH or PUSCH transmission that includes one or more HARQ-ACK feedbacks associated to one or more different priority index as a function of at least one of the following.

Whether multiplexing or skipping is configured. For example, the UL PC formula may be determined based on whether the WTRU is configured to use multiplexing or skipping in the event of overlapping HARQ-ACK or UCI feedback.

Whether multiplexing or skipping is used in the transmission. For example, the UL PC formula may be determined or adjusted based on whether the actual transmission includes multiplexed HARQ-ACK or UCI of different priority. In another example, the UL PC formula may be determined or adjusted based on whether a HARQ-ACK or UCI was skipped due to overlapping transmissions for that HARQ-ACK or UCI transmission instance.

The coding type used. For example, the UL PC formula may be adjusted as a function of the type of coding used for the multiplexing of HARQ-ACK or UCI in the transmission. The types of coding may include joint, separate, partial joint or the error control code used.

The number of multiplexed HARQ-ACK or UCI of same or different priorities. For example, the UL PC formula may be adjusted as a function of the total number of multiplexed HARQ-ACK or UCI. In another example, the UL PC formula may be adjusted as a function of the number of different sets of feedbacks, where each set is composed of all HARQ-ACK or UCI of a same priority.

The number of information or coded bits, possibly of each priority. For example, the UL PC formula may be adjusted as a function of the total number of multiplexed information or coded bits, or the number of information or coded bits of high priority only, or low priority only, or priority x only, or a combination thereof. In another example, the UL PC formula may be adjusted as a function of the sum of information or coded bits of a set of priorities of HARQ-ACK or UCI multiplexed in the transmission. In another example, the UL PC formula may be adjusted by a first offset or scaling value determined by the number of high priority information or coded bits and a second offset or scaling value determined by the number of low priority information or coded bits.

The coding rate used. The UL PC formula may be adjusted as a function of the coding rate used for the high priority HARQ-ACK or UCI or low priority HARQ-ACK or UCI. The UL PC formula may be adjusted as a function of the ratio between the coding rates of the high and low priority HARQ-ACK or UCI.

The payload. For example, the UL PC formula may be adjusted as a function of the total HARQ-ACK or UCI payload, or the payload of high priority HARQ-ACK or UCI, or the payload of low priority HARQ-ACK or UCI. In another example, the UL PC formula may be adjusted or determined as a function of the normalized payload, as described herein.

The UCI Type. For example, the UL PC formula may be adjusted or determined as a function of the UCI type and possibly the associated priority of each UCI type. For example, the UL PC formula may be adjusted as a function of the multiplexed UCI types (HARQ-ACK, CSI, SR) and the associated priority of each UCI. In another example, the UL PC formula may be adjusted as a function of the payload or number of information or coded bits of each UCI type along with the associated priority. For the case where the WTRU may multiplex two transmissions of a same UCI type with different priority, the adjustment may be determined as a function of the different payloads associated with different priorities.

The PUCCH format. For example, the UL PC formula may be determined or adjusted as a function of the PUCCH format used. In another example, the UL PC formula may be determined or adjusted if the PUCCH format has been changed due to the multiplexing of multiple HARQ-ACK or UCI of same or different priority.

Whether PUCCH is multiplexed with PUSCH. For example, the UL PC formula may be determined or adjusted as a function of whether PUCCH is multiplexed with PUSCH. Furthermore, the UL PC formula may be determined or adjusted as a function of the priority of the PUCCH and/or PUSCH.

The resource allocation. For example, the UL PC formula may be determined or adjusted as a function of the resource allocation of the multiplexed transmission, or the resource allocation associated with the high priority HARQ-ACK or UCI (i.e. if no multiplexing were used), or the resource allocation associated with the low priority HARQ-ACK or UCI (i.e. if no multiplexing were used), or a combination thereof.

The priority of the PUCCH or PUSCH transmission may also be used.

The normalized or hybrid priority of the PUCCH or PUSCH transmission may also be used, as described herein.

The adjustment of the UL PC formula may be determined as an offset value added or multiplied to the UL PC formula. In another method, the adjustment of the UL PC formula may be determined as a scaling factor of an existing component or offset of the UL PC formula.

A PUCCH or PUSCH transmission used to transmit multiplexed HARQ-ACK or UCI of different priorities may be associated with a hybrid priority value. The hybrid priority value may be determined by at least one of highest priority index of all the multiplexed transmissions, lowest priority index of all the multiplexed transmissions, average priority index of all the multiplexed transmissions, and a weighted average of the priority indices of all the multiplexed transmissions, where the weighted average may be determined as a function of the number of transmissions associated to each priority, or the number of information or coded bits associated with each priority.

Power control for PUCCH may include an adjustment term that is a function of a ratio between a number of UCI information bits and a number of resource elements available for coded UCI bits. Such ratio may be referred to as “bits per resource element” or BPRE. In some examples, the adjustment may be a first function of BPRE (e.g., a linear function) if the number of UCI information bits is below a threshold, and a second function of BPRE (e.g., an exponential function) if the number of UCI information bits is equal or higher than a threshold.

In some examples, the WTRU may calculate a power adjustment term for PUCCH when the PUCCH includes a first number (Ohp) of high-priority HARQ-ACK bits and a second number (Olp) of low-priority HARQ-ACK bits by determining or estimating the BPRE of high-priority HARQ-ACK bits only.

In one example, the WTRU may determine that the BPRE of high-priority HARQ-ACK bits is equal to a determined configured maximum coding rate (Rhp) times a modulation order for high-priority HARQ-ACK bits.

In another example, the WTRU may determine that the BPRE of high-priority HARQ-ACK bits (BPRE_{HP}) is calculated based on Eq. 1:

$$B P R {E}_{H P} = ( Olp rhp / rlp + Ohp ) / Nre , \qquad Equation . 1$$

where rhp and rlp may be a determined configured maximum coding rate for high-priority and low-priority HARQ-ACK bits, respectively, and Nre may be a total number of resource elements available for coded UCI bits. Alternatively, rhp and rlp may correspond to actual coding rates of high-priority and low-priority HARQ-ACK bits, respectively, after rate matching.

The prioritization for power reduction is included. If the total transmission power for PUCCH and/or PUSCH and/or PRACH and/or SRS transmissions on a serving cell exceeds Pcmax, the WTRU may scale the power of some transmissions or may drop some transmissions. The power allocation may be done in the following order, such that a higher priority transmission may be allocated all required power and a lower priority transmission may be scaled or dropped if necessary: high priority PRACH, low priority PRACH, PUCCH or PUSCH with highest priority index, high priority SRS transmission, and low priority SRS transmission.

The priority index of the PUCCH or PUSCH may be determined by at least one of: highest priority index of the multiplexed elements, lowest priority index of the multiplexed elements, hybrid priority (as described herein). For PUCCH or PUSCH with the same priority index, the UL PC prioritization may be determined as a function of the contents of the transmission (e.g., HARQ-ACK, CSI, SR, Link Recovery Request), whether multiplexing is used, and the priority of each multiplexed element.

A minimum UL transmission power requirement may be associated with a lower priority transmission. If the requirement cannot be satisfied, the transmission may be skipped. A minimum UL transmission power requirement may be associated with a higher priority transmission. If the requirement cannot be satisfied, a lower priority transmission may be skipped, or multiplexing may be disabled for the transmission. A minimum UL transmission power requirement may be associated with a multiplexed transmission. If the requirement cannot be satisfied, multiplexing may be disabled for the transmission and a lower priority transmission may be skipped.

Rate matching for separate coding of multiplexed UCI is also included. In some examples, the rate matching for separate coding of multiplexed UCI may be performed jointly or separately. When rate matching is performed jointly, both high priority HARQ-ACK or UCI and low priority HARQ-ACK or UCI may be equally affected by the rate matching function. For example, the coding rate of both HARQ-ACKs or UCIs may be equivalently scaled.

In another method, the rate matching may be performed separately, such that the effect of rate matching may be different for high priority and low priority HARQ-ACK or UCI. To achieve separate rate matching, when determining the number of rate matched sequence length, the number of high priority HARQ-ACK bits may be scaled by a first offset value or scaling factor and the number of low priority HARQ-ACK bits may be scaled by a second offset value or scaling factor. The scaling or the ratio of the two scaling factors may be determined from a minimum coding rate ratio. If the WTRU is configured with first and second maximum coding rate parameters for high-priority and low-priority HARQ-ACK, the WTRU may follow a procedure already outlined in the above to select either first or second maximum coding rate parameters and apply rate matching procedure using the selected maximum coding rate parameter (at least for high-priority HARQ-ACK).

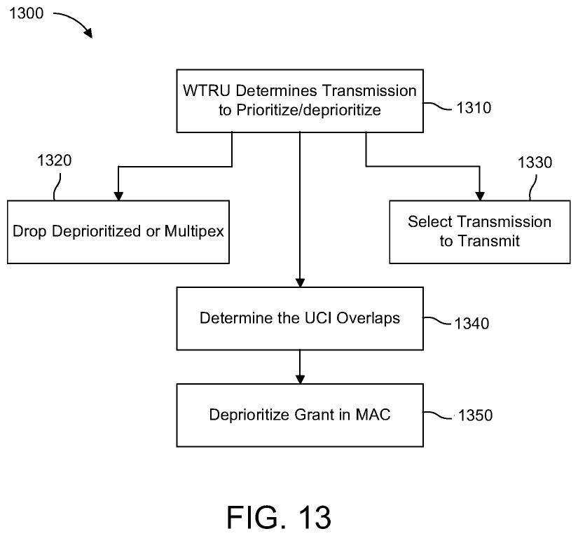

The WTRU may determine that two or more transmissions of control, data, and/or physical layer signals are overlapping in the time and/or frequency domain. After determining the overlap, the WTRU may follow a procedure to determine which of the overlapping transmissions to transmit and/or multiplex together. An example of such a procedure or method 1300 is provided in FIG. 13. As described above, with respect to FIGS. 2-7 and the present systems and methods, including the examples 200, 300, 400, 500, 600, 700 where control of multiplexing occurs, transmission selection and skipping may be employed. Transmission selection and multiplexing may occur on the UCI on a PDU without data.

Method 1300 includes, at 1310, the WTRU may determining which transmission is prioritized or de-prioritized. At 1320, the WTRU may drop a deprioritized transmission (i.e., discard the grant and/or store the related PDU—if generated—for a later in the HARQ process (re)-transmission) or multiplex it with another selected transmission. At 1330, the WTRU may use the designation of prioritized vs. de-prioritized transmission to select which of the overlapping transmissions to transmit. A transmission can be a PUSCH, PUCCH, SRS, a UCI, SR, and other control info transmission or signal. Grant herein is used to refer to a PUSCH resource applicable for transmission of data and possibly some control information/element, either a dynamic grant (DG) or a configured grant (CG). At 1340, the WTRU may determine that UCI overlaps with a grant if it has UCI to transmit and there is PUCCH resource overlapping with another PUSCH resource, or the UCI can be transmitted on more than one PUSCH grant that overlap. At 1350, a grant may be deprioritized in MAC if another grant overlaps with it and has high priority LCH(s) form which data can be multiplexed on it, or in PHY if another grant or PUCCH transmission overlaps with it and has a high priority level.

With uplink skipping configured, the WTRU MAC may not generate a PDU if the PDU contains only padding bits (or the number of data bits is less than a threshold). Uplink skipping can be configured for DG and CG separately. In some conditions when uplink skipping is configured, the WTRU may still generate a PDU for the purpose of multiplexing UCI on it even when there is only padding bits multiplexed on it, e.g., when PUCCH resource is overlapping with the PUSCH resource.

A transmission selection procedure may be employed. If LCH based prioritization is configured, the WTRU MAC may follow specified rules for grant selection between overlapping grants. The WTRU MAC may discard grant(s) determined as “de-prioritized” by the WTRU MAC and may build PDUs for other prioritized grants. The WTRU MAC may discard grant(s) for which the conditions for uplink skipping are satisfied, except for the purpose of multiplexing UCI.

From the set of prioritized transmissions/grants determined by WTRU MAC, the physical layer may further select a grant for transmission if the overlapping transmissions are associated with different physical layer priority indices, e.g., by dropping the transmission associated with the “low” physical layer priority level/index. WTRU PHY may determine to multiplex UCI with an overlapping prioritized grant for which a TB/PDU was generated, and this may be governed by predefined rules.

In one method, the WTRU multiplexes the UCI on a prioritized grant for which a TB was built in some conditions, including at least one of the following: the grant is a dynamic grant, the grant is configured grant, the priority of the grant is higher than or equal to the priority of the UCI, where priority can be determined based on the physical layer priority level/index, the UCI priority is higher than or equal to the priority of the overlapping grant, the UCI type includes one or more of the following types: HARQ ACK, SR, CQI, or SRS, the UCI can be multiplexed with sufficient reliability as described herein, and the reliability of the grant is not decreased upon multiplexing UCI as described herein. For example, sufficient reliability may be achieved where the multiplexing beta factor is larger than a certain threshold or the reliability (e.g., BLER) of the transmission is not reduced below a certain threshold.

The WTRU may drop the transmission of a UCI overlapping with another prioritized grant or transmission if it cannot be multiplexed on any of the overlapping transmissions. The WTRU may consider whether the overlapping transmissions can be transmitted simultaneously before dropping the de-prioritized transmission. For example, the WTRU may be capable of transmitting both PUSCH and PUCCH simultaneously in some conditions, including, e.g., if they don't overlap in the frequency domain, if they are on different carriers or BWPs, if they are both of the same or high priority level, and/or if the WTRU receives a dynamic indication to do so.

The WTRU may generate a TB for a grant overlapping with UCI for the purpose of UCI multiplexing even if the conditions for UL skipping are satisfied. For example, if one or more of the following conditions are met: the UCI does not overlap with any other prioritized transmissions, other overlapping grants to not have data than can be multiplexed on them (e.g., skipped grants), per the LCP procedure, the grant is a dynamic grant, the grant is configured grant, there is no overlapping dynamic grant, there is no overlapping prioritized grant (e.g., a prioritized CG), the priority of the grant is higher than or equal to the priority of the UCI, where priority can be determined based on the physical layer priority level/index, priority of the UCI is greater than or equal to the priority of the grant, depending on padding bits (e.g., if some data bits can be multiplexed on the grant), if no data bits can be multiplexed on the grant (only padding bits), or if the number of data bits that can be multiplexed is less than a certain threshold, the UCI can be multiplexed with sufficient reliability. The reliability of the grant is not decreased upon multiplexing UCI, the UCI type includes one or more of the following: HARQ ACK, SR, CQI, or SRS., depending on whether LCH based prioritization is configured or not configured, depending on whether low/high physical layer priority levels are configured and depending on whether UL skipping is configured for DL and/or CG.

The WTRU may transmit UCI on PUCCH if no UCI transmission overlaps with a grant for which multiplexing is possible, if priority of PUCCH resource is higher than priority of the overlapping grant on which UCI multiplexing is possible, or if the overlapping grant is deprioritized. For example, the WTRU may transmit UCI on PUCCH if UCI overlaps with a PUSCH deprioritized by another overlapping PUSCH (UCI cannot be multiplexed on that grant).

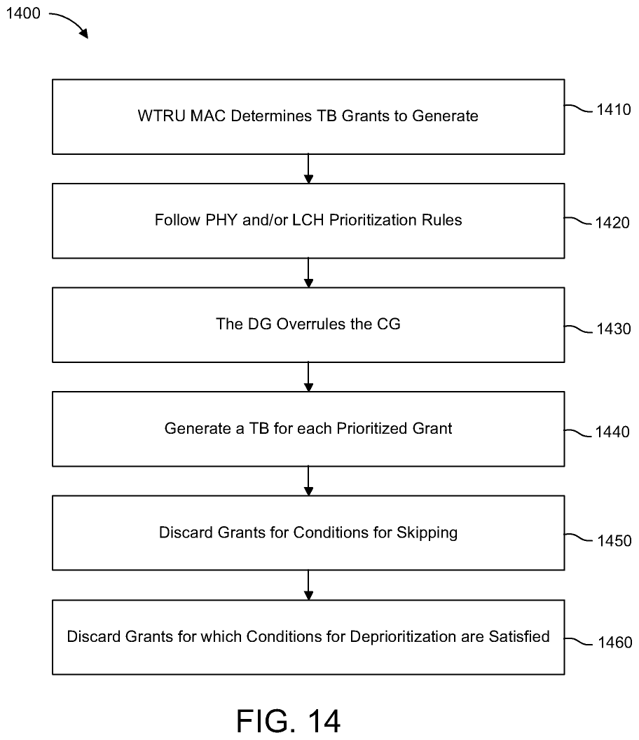

FIG. 14 illustrates a method 1400 to determine which of the overlapping transmission is selected/transmitted and whether to build a TB for a grant overlapping with other transmission. The WTRU may follow some of the following method to determine which of the overlapping transmission should be selected/transmitted and whether to a build a TB for a grant overlapping with other transmission(s). Method 1400 includes, at 1410, the WTRU MAC determines to generate and prioritize the grant(s) of a TB. In case of overlapping grants, at 1420, the PHY and/or LCH prioritization rules are followed. At 1430, the DG overrules CG. At 1440, a TB for each prioritized grant is generated. At 1450, grants for which Conditions for skipping are discarded, except for the purpose of multiplexing UCI. At 1460, grants for which Conditions for de-prioritization are satisfied are discarded. If an overlap with UCI transmission would occur for a prioritized grant for which TB is generated, follow existing spec (UCI will be multiplexed in that PUSCH, or one of the transmissions may be dropped). Otherwise (e.g., UCI doesn't overlap with any prioritized transmission), possibly generate a TB for a PUSCH for the purpose of multiplexing UCI. If UCI transmission overlaps with one or more grant(s) for which multiplexing is possible, generate TB for that grant and multiplex UCI on PUSCH.

In case DG and CG both overlap, generate TB for the DG. If multiplexing between different priorities is configured and possible (conditions TBD, e.g., based on UCI type, grant type, or priority), multiplexing may occur with grant of same priority, in case multiple grants are available. If no UCI transmission overlaps with a grant for which multiplexing is possible, transmit UCI on PUCCH (e.g., when UCI overlaps with a PUSCH deprioritized by another overlapping PUSCH, UCI cannot be multiplexed on that grant).

The WTRU may follow some of the following procedure to determine which of the overlapping transmission should be selected/transmitted and whether to a build a TB for a grant overlapping with other transmission(s). If LCH based prioritization is configured: WTRU MAC may select grant(s) of the highest PHY priority. WTRU MAC may generate a PDU for the grant on which highest LCH priority with buffered data can be transmitted. WTRU MAC may discard deprioritized grants. Select the transmission of highest priority and prepare it for transmission. A check to determine if any of the other deprioritized transmissions do not overlap with prioritized transmission may occur. If the determination is positive (yes), transmit the other non-overlapping deprioritized transmissions as well, otherwise, drop other drop other deprioritized transmission (or preempt them if already ongoing). Multiplex UCI on the prioritized tx if no PUCCH was selected (e.g., if prioritized PUSCH reliability not impacted) or the other PUSCH if it is decided to be transmitted in step 2 and priority of PUSCH is larger than or equal to priority of UCI.

If two overlapping transmissions are of same priority, select PUSCH and multiplex UCI on the selected PUSCH (e.g., if reliability not impacted/MAC determines) and drop the PUSCH if it is on a CG. WTRU MAC may discard/skip grants that overlap with UCI of higher PHY priority, or grants on which UCI cannot be multiplexed and/or no data can be transmitted.

A WTRU supporting simultaneous PUCCH and PUSCH transmission may report a Power Headroom Report (PHR) Type 2. PHR Type 2 may indicate the power headroom (positive or negative) available for a simultaneous PUCCH/PUSCH transmission. The simultaneous PUCCH and PUSCH considered in a Type 2 PHR may be simultaneously transmitted in the same or different carrier, BWP, subband (e.g., LBT subband) and/or cell group. In a method, the simultaneous PUCCH and PUSCH considered in a Type 2 PHR may overlap partially or completely in the frequency domain. The simultaneous PUCCH and PUSCH considered in a Type 2 PHR may completely or partially overlap in time.

A WTRU may support transmission of multiple priorities. For example, the WTRU may support multiple priorities for PUCCH and for PUSCH. A WTRU may assume a specific combination of PUCCH and PUSCH priorities in a Type 2 PHR. For example, if a WTRU supports two priority levels for PUCCH and PUSCH (e.g., priority 0 and 1), then a Type 2 PHR may include at least one of the following combinations: PUCCH priority 0, PUSCH priority 0, PUCCH priority 0, PUSCH priority 1, PUCCH priority 1, PUSCH priority 0, and PUCCH priority 1, PUSCH priority 1. Each possible combination of priorities may be deemed a Type 2 PHR state. In a solution, a single Type 2 PHR may include values for multiple priority combinations or Type 2 PHR states.

The Type 2 PHR may be determined as a function of at least one of resource allocation for a PUSCH, resource allocation for a PUCCH, nominal power for PUCCH, nominal power for PUSCH, numerology, transmit power command or adjustment state for PUCCH, transmit power command or adjustment state for PUSCH, path loss, maximum power for a carrier, an offset (or alpha value or delta value), priority of PUCCH, priority of PUSCH, whether multiplexing or skipping is configured or used, whether separate, joint, or partial joint coding is used for multiplexing HARQ-ACK or UCI, the coding rate of each multiplexed UCI component, or the normalized coding rate, and the priority or hybrid priority of PUCCH or PUSCH if multiplexing is assumed.

A Type 2 PHR may be determined as a function of scheduled or non-scheduled PUSCH and prepared or unprepared PUCCH. For the case where a PUSCH is non-scheduled, a WTRU may use a virtual PUSCH transmit power in the PHR calculation. Similarly, for the case where a PUCCH is unprepared, a WTRU may use a virtual PUCCH transmit power in the PHR calculation. The virtual transmit power assumption may assume the smallest possible resource assignment.

In another method, the virtual transmit power calculation may depend on the priority of the transmission. For example, for a high priority transmission, a resource assignment larger than the smallest possible one may be used. In another method, the virtual transmit power assumption may be configurable (e.g., per priority level).

For an unscheduled PUSCH or unprepared PUCCH, the WTRU may determine a virtual priority. For example, for either an unscheduled PUSCH or unprepared PUCCH, the WTRU may be configured as a priority.

A WTRU may maintain or calculate multiple Type 2 PHR state values. For example, a WTRU with two priority levels for PUCCH and PUSCH may maintain or calculate up to four Type 2 PHR state values. The WTRU may report a single Type 2 PHR state value. A WTRU may determine the appropriate Type 2 PHR state value to report as a function of: a WTRU may determine as a function of the RRC configuration, and/or a WTRU may be RRC configured with a specific Type 2 PHR state for which it may perform reports. In another example, a WTRU may be configured with resources (e.g., periodic resources) on which it may report a specific Type 2 PHR state. The WTRU may have multiple such configurations (e.g., one periodic reporting configuration per Type 2 PHR state). This may enable the WTRU to report PHR for different priority combinations.

A WTRU may determine the appropriate Type 2 PHR state value to report based on a PUSCH grant. For example, a parameter of the grant may determine the Type 2 PHR state to be reported. For example, the priority of the grant may indicate the Type 2 PHR state to be reported.

A WTRU may determine the appropriate Type 2 PHR state value to report as a function of whether or not there is scheduled PUSCH and/or whether or not there is prepared PUCCH. If there is scheduled PUSCH, the WTRU may use the priority of the scheduled PUSCH as priority of the PUSCH in the Type 2 PHR. If there is prepared PUCCH, the WTRU may use the priority of the scheduled PUCCH as priority of the PUCCH in the Type 2 PHR. If there are multiple TBs multiplexed into the PUSCH, the WTRU may determine the priority of the PUSCH in the Type 2 PHR as a function of the priorities of one or more of the multiple TBs (e.g., select the highest or lowest priority). If there are multiple UCIs to be multiplexed into the PUCCH, the WTRU may determine the priority of the PUCCH in the Type 2 PHR as a function of the priorities of one or more multiple UCIs (e.g., select the highest or lowest priority). If there is no scheduled PUSCH, the WTRU may use a fixed or configurable priority for the PUSCH in the Type 2 PHR. If there is no scheduled PUCCH, the WTRU may use a fixed or configurable priority for the PUCCH in the Type 2 PHR.

A WTRU may determine the appropriate Type 2 PHR state value to report as a function of whether the WTRU is actively building UCI to be reported. For example, a WTRU may determine the Type 2 PHR state to report as a function of whether it is currently building UCI (e.g., HARQ feedback) or whether it is expected to transmit such UCI within a time window or the priority of such UCI. The WTRU may determine the Type 2 PHR as a function of the priority (or hybrid priority) of the UCI being built. The WTRU may determine the Type 2 PHR as a function of whether the UCI being actively built requires multiplexing.

A WTRU may determine the appropriate Type 2 PHR state value to report as a function of the MAC CE indication. For example, a WTRU may switch between a set of Type 2 PHR states as a function of receiving a MAC CE switching indication.

A WTRU may determine the appropriate Type 2 PHR state value to report as a function of the DCI indication. For example, a WTRU may switch between a set of Type 2 PHR states as a function of receiving a DCI switching indication.

A WTRU may determine the appropriate Type 2 PHR state value to report as a function of the frequency location of the PUCCH and/or PUSCH. For example, the state can be determined as a function of whether or not there is overlap in the frequency domain.

A WTRU may determine the appropriate Type 2 PHR state value to report as a function of the timing of the PUCCH and/or PUSCH. For example, the state can be determined as a function of whether or not there is overlap in the time domain, and possibly the amount of overlap.

A WTRU may determine the appropriate Type 2 PHR state value to report as a function of the PHR trigger. For example, a PHR may be triggered by a change of PL or by an expiration of a prohibit time period or by a change (or expected change) in the priority of a transmission. The time period may be tracked by a timer or other tracking method. The WTRU may determine the Type 2 PHR state as a function of the trigger type. In another example, the WTRU may determine the Type 2 PHR state as a function of the change in a parameter that led to a PHR transmission. For example, if the priority changes from low to high, the WTRU may determine a first state, if the priority changes from high to low, the WTRU may determine a second state.

A WTRU may determine the appropriate Type 2 PHR state value to report as a function of the PUCCH or PUSCH repetition. For example, the Type 2 PHR state may be determined as a function of whether PUCCH or PUSCH repetition is used. The Type 2 PHR state may be determined as a function of the PUCCH or PUSCH repetition type or number.

A WTRU may determine the appropriate Type 2 PHR state value to report as a function of whether multiplexing or skipping is configured or used. A WTRU may determine as a function of whether separate, joint, or partial joint coding is used for multiplexing HARQ-ACK or UCI.

In a method where the WTRU determines Type 2 PHR state to report, the WTRU may indicate the Type 2 PHR state that is reported. The indication of the Type 2 PHR state may be transmitted with the Type 2 PHR. The indication of the Type 2 PHR state may be performed using a MAC CE element, grant type and PHR codepoints. For MAC CE element, for example, the WTRU may include a bit string indicating the Type 2 PHR state.

For grant type, for example a WTRU may select a specific grant to include the Type 2 PHR as a function of the Type 2 PHR state. For PHR codepoints, for example, a WTRU may be configured with multiple sets of PHR codepoints. Each set may be associated to a Type 2 PHR state. A WTRU may report multiple values for multiple Type 2 PHR states by including multiple PHR codepoints in the PHR transmission. In another example, a WTRU may be configured with a set of PHR codepoints. Each codepoint may be associated with a set of PHR values for a set of Type 2 PHR states. In such a method, the WTRU may report PHR values for multiple Type 2 PHR states in a single PHR transmission.

A WTRU may determine when to transmit a Type 2 PHR report. The transmission timing may be periodic or dynamically triggered. The WTRU may determine when to transmit a Type 2 PHR report as a function of at least one of: RRC configuration, change in path loss, based on a timer or time period, based on a PUSCH grant, based on UCI in a PUCCH, whether UCI or TB multiplexing is used, whether a TB or UCI was previously skipped/dropped, whether a UE is building UCI to be transmitted, if UCI is to be transmitted in an upcoming PUCCH resource, and to reduce padding. When the timing is based on an RRC configuration, for example, the WTRU may be configured with periodic instances when to report Type 2 PHR.

When the timing is based on a change in path loss (PL), for example, a WTRU may be triggered to transmit a Type 2 PHR when the PL changes by more than a threshold.

When the timing is based on a timer or time period, for example, a WTRU may transmit a Type 2 PHR upon expiration of a prohibit time period. The WTRU may maintain a set of prohibit timer periods, for example, each associated with a different Type 2 PHR state. A prohibit time period may be restarted upon transmission of a Type 2 PHR. For example, the prohibit time period associated to a state may be restarted upon transmission of a Type 2 PHR for that state or another (e.g., default) state. In another example, the prohibit time period associated to any state may be restarted upon transmission of a Type 2 PHR report for any state. It should be noted that a prohibit time period may be measured or tracked using a time clock or timer, counter that counts up or down, or any other means for measuring the elapse of a time period.

When the timing is based on a PUSCH grant, for example, a WTRU may be triggered to transmit a Type 2 PHR if a PUSCH grant indicates a different priority than that used for a preceding (e.g., immediately preceding) PUSCH transmission and/or Type 2 PHR transmission.

When the timing is based on UCI in a PUCCH, for example, a WTRU may be triggered to transmit a Type 2 PHR if the UCI in a PUCCH is of a different priority than that used for a preceding (e.g., immediately preceding) PUSCH transmission and/or Type 2 PHR transmission.

When the timing is based on whether a TB or UCI was previously skipped/dropped, for example, a WTRU may report a Type 2 PHR if the associated PUSCH or PUCCH include a TB or UCI that was previously skipped/dropped (e.g., due to being lower priority).

When the timing is based on whether a WTRU is building UCI to be transmitted. For example, if a WTRU is currently building a HARQ codebook for transmissions of a specific priority, the WTRU may trigger a Type 2 PHR of a specific Type 2 PHR state (e.g., a state that is determined from the priority of the UCI).

When the timing is based on if UCI is to be transmitted in an upcoming PUCCH resource, for example, if the WTRU has periodic UCI to report un an upcoming PUCCH, the WTRU may trigger a Type 2 PHR. The Type 2 PHR state for such a transmission may depend on the priority of the associated UCI.

When the timing is to reduce padding, for example, a WTRU may report a Type 2 PHR to reduce the amount of padding of a MAC PDU. The WTRU may determine the number of Type 2 PHR states and the set of Type 2 PHR states to report. Such determination may be performed as a function of the number of padding bits assigned to the MAC PDU.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for determining a downlink assignment index (DAI) for a low-priority HARQ-ACK codebook based on a field received in a downlink control information (DCI) indicating a high-priority physical uplink control channel (PUCCH) transmission or physical uplink shared channel (PUSCH) transmission, the method comprising:
determining a first DAI value for low-priority HARQ-ACK codebook in a first DCI indicating a high-priority PUCCH transmission or PUSCH transmission;
determining a low-priority HARQ-ACK codebook to multiplex with high-priority HARQ-ACK codebook or PUSCH transmission corresponding to the first DCI;
adjusting a size of the low-priority HARQ-ACK codebook to be consistent with the first DAI value; and
multiplexing the low-priority HARQ-ACK codebook with the high-priority HARQ-ACK codebook or PUSCH transmission.

2. The method of claim 1 wherein the adjusting the size of the low-priority HARQ-ACK codebook to be consistent with the first DAI value includes appending zeros.

3. The method of claim 1 wherein the first DAI value indicates the low-priority HARQ-ACK codebook is priority 0.

4. The method of claim 1 wherein the first DAI value indicates that the low-priority HARQ-ACK codebook is priority 1.

5. The method of claim 1 wherein the first DAI value indicates a configuration to disable multiplexing with a HARQ-ACK codebook of priority index 0.

6. The method of claim 5 wherein the first DAI value indicates disabling multiplexing into a PUSCH transmission.

7. The method of claim 5 wherein the first DAI indicates enabling multiplexing into a PUSCH transmission.

8. A wireless transmit receive unit (WTRU) for determining a downlink assignment index (DAI) for a low-priority HARQ-ACK codebook based on a field received in a downlink control information (DCI) indicating a high-priority physical uplink control channel (PUCCH) transmission or physical uplink shared channel (PUSCH) transmission, the WTRU comprising:
a processor; and
a transceiver operatively coupled to the processor,
the processor configured to determine a first DAI value for low-priority HARQ-ACK codebook in a first DCI indicating a high-priority PUCCH transmission or PUSCH transmission;
the processor configured to determine a low-priority HARQ-ACK codebook to multiplex with high-priority HARQ-ACK codebook or PUSCH transmission corresponding to the first DCI;
the processor configured to adjust the size of the low-priority HARQ-ACK codebook to be consistent with the first DAI value; and
the processor configured to multiplex the low-priority HARQ-ACK codebook with the high-priority HARQ-ACK codebook or PUSCH transmission.

9. The WTRU of claim 8 wherein the adjusting the size of the low-priority HARQ-ACK codebook to be consistent with the first DAI value includes appending zeros.

10. The WTRU of claim 8 wherein the first DAI value indicates the low-priority HARQ-ACK codebook is priority 0.

11. The WTRU of claim 8 wherein the first DAI value indicates that the low-priority HARQ-ACK codebook is priority 1.

12. The WTRU of claim 8 wherein the first DAI value indicates a configuration to disable multiplexing with a HARQ-ACK codebook of priority index 0.

13. The WTRU of claim 12 wherein the first DAI value indicates disabling multiplexing into a PUSCH transmission.

14. The WTRU of claim 12 wherein the first DAI indicates enabling multiplexing into a PUSCH transmission.

15. A method performed in a WTRU comprising:
receiving a first downlink (DL) control information (DCI−) including an indication of first physical downlink shared channel (PDSCH) transmission, a resource for a first physical uplink control channel (PUCCH) transmission, a priority of the first PUCCH transmission, a physical uplink shared channel (PUSCH) multiplexing indication and a HARQ multiplexing indication;
receiving an indication of a resource for a first PUSCH occasion with lower priority than a first PUCCH occasion where the first PUCCH occasion and the first PUSCH occasion overlap;
determining a resource to transmit HARQ feedback for the first PDSCH transmission based on the PUSCH multiplexing indication and the HARQ multiplexing indication, and white the WTRU receives an indication of a resource for a second PUCCH with lower priority than the first PUCCH occasion that overlaps in time with the first PUCCH occasion; and
transmitting the HARQ feedback for the first PDSCH transmission using the determined resource based on the PUSCH multiplexing indication.

16. The method of claim 15 wherein the determined resource is the first PUCCH resource.

17. The method of claim 15 wherein the determined resource is the first PUSCH resource.

18. The method of claim 15 wherein if the WTRU receives an indication of a second PDSCH transmission and a resource for a second PUCCH occasion with lower priority than the first PUCCH occasion that overlaps with the first PUCCH resource, the transmitting occurs on the first PUSCH resource.

19. The method of claim 18 wherein the transmitting further includes the HARQ feedback for the second PDSCH transmission.

20. The method of claim 15 wherein if an indication of a second PUCCH occasion with lower priority than the first PUCCH occasion that overlaps with the first PUCCH resource is not received by the WTRU, the transmitting occurs as a PUCCH transmission on the first PUCCH occasion.
